(19) United States
(12) Patent Application Publication
(10) Pub. No.: US 2023/0262758 A1
(43) Pub. Date: Aug. 17, 2023

(54) METHOD AND DEVICE FOR PERFORMING SENSING IN WIRELESS LAN SYSTEM

(71) Applicant: LG Electronics Inc., Seoul (KR)

(72) Inventors: Sanggook KIM, Seoul (KR); Dongguk LIM, Seoul (KR); Insun JANG, Seoul (KR); Jeongki KIM, Seoul (KR); Jinsoo CHOI, Seoul (KR)

(21) Appl. No.: 18/010,598

(22) PCT Filed: Jun. 15, 2021
(86) PCT No.: PCT/KR2021/007476

§ 371 Date: Dec. 15, 2022

Related U.S. Application Data
(60) Provisional application No. 63/039,428, filed on Jun. 15, 2020.

(51) Int. Cl. H04W 74/08; H04W 24/10

(52) U.S. Cl. CPC H04W 74/0808; H04W 24/10; H04W 84/12

(57) ABSTRACT

A transmission STA in a wireless local area network system can transmit a sensing start frame. The sensing start frame can comprise information relating to a feedback method and feedback frequency. The feedback method can comprise information relating to at least one of an explicit feedback, implicit feedback and hybrid feedback. The transmission STA can transmit a sensing frame to a reception STA. The transmission STA can receive from the reception STA a feedback frame comprising channel state information obtained on the basis of the sensing frame. The sensing start frame can further comprise information relating to the number of sensing frame transmissions. The information relating to feedback frequency can comprise information relating to the number of received sensing frames prior to the transmission of the feedback frame by the reception STA.

### TECHNICAL FIELD

The present specification relates to a technique for performing sensing in a WLAN system, and more particularly, to a procedure and signaling method for performing sensing by a sensing initiator and a sensing responder stations (STAs).

### BACKGROUND

A wireless local area network (WLAN) has been improved in various ways. For example, IEEE 802.11bf WLAN sensing is the first standard which converges communication and radar technologies. Although there is a rapid increase in a demand for unlicensed frequencies in daily life throughout overall industries, due to a limitation in frequencies to be newly provided, it is very preferable to develop the technology of converging the communication and the radar in terms of increasing frequency utilization efficiency. A sensing technology which detects a movement behind a wall by using a WLAN signal or a radar technology which detects an in-vehicle movement by using a frequency modulated continuous wave (FMCW) signal at a 70 GHz band has been conventionally developed, but it may have significant meaning in that sensing performance can be raised up by one step in association with the IEEE 802.11bf standard. In particular, since privacy protection is increasingly emphasized in modem society, a WLAN sensing technology which is legally freer from invasion of privacy is more expected, unlike CCTV.

Meanwhile, an overall radar market throughout automobiles, national defense, industries, daily life, or the like is expected to grow until an average annual growth rate reaches up to a level of about 5% by 2025. In particular, in case of a sensor used in daily life, it is expected to rapidly grow up to a level of 70%. Since the WLAN sensing technology is applicable to a wide range of daily life such as motion detection, breathing monitoring, positioning/tracking, fall detection, in-vehicle infant detection, appearance/proximity recognition, personal identification, body motion recognition, behavior recognition, or the like, it is expected to contribute to enhancing competitiveness of companies.

### SUMMARY

In a wireless local area network (WLAN) system according to various embodiments, a transmitting STA may transmit a sensing initiation frame. The sensing initiation frame may include information related to a feedback method and feedback frequency. The feedback method may include information related to at least one of explicit feedback, implicit feedback, and hybrid feedback. The transmitting STA may transmit a sensing frame to the receiving STA. A transmitting STA may receive a feedback frame including channel state information obtained based on the sensing frame from the receiving STA. The sensing initiation frame may further include information related to the number of transmissions of the sensing frame. The information related to the feedback frequency may include information related to how many sensing frames the receiving STA transmits after receiving a feedback frame.

According to an example of the present specification, more accurate sensing performance can be implemented by using both the explicit feedback method and the implicit feedback method depending on circumstances.

According to the embodiments of the present specification, both explicit or implicit feedback and explicit and implicit feedbacks (hybrid) methods can be supported, so that an optimal method according to the situation can be implemented.

### BRIEF DESCRIPTION OF THE DRAWINGS

FIG. 1 illustrates an example of a transmitting apparatus and/or receiving apparatus of the present specification.

FIG. 2 illustrates an example of a WLAN sensing scenario using multiple sensing transmitting apparatuses.

FIG. 3 illustrates an example of a WLAN sensing scenario using multiple sensing receiving apparatuses.

FIG. 4 illustrates an example of a WLAN sensing procedure.

FIG. 5 is an example of classifying WLAN sensing.

FIG. 6 illustrates indoor positioning which uses CSI-based WLAN sensing.

FIG. 7 is an example of implementing a WLAN sensing apparatus.

FIG. 8 briefly illustrates a PPDU structure supported in an 802.11ay WLAN system.

FIG. 9 illustrates an example of a PPDU used in the present specification.

FIG. 10 is a diagram illustrating an embodiment of a connection form of WLAN sensing devices (stations).

FIG. 11 to FIG. 14 are diagrams illustrating an embodiment of an explicit feedback operation method.

FIG. 15 to FIG. 19 are diagrams illustrating an embodiment of an implicit feedback operation method.

FIG. 20 to FIG. 23 are diagrams illustrating an embodiment of a hybrid feedback operation method.

FIG. 24 is a diagram illustrating an embodiment of a method of operating a transmitting STA.

FIG. 25 is a diagram illustrating an embodiment of a method of operating a receiving STA.

### DETAILED DESCRIPTION

In the present specification, “A or B” may mean “only A”, “only B” or “both A and B”. In other words, in the present specification, “A or B” may be interpreted as “A and/or B”. For example, in the present specification, “A, B, or C” may mean “only A”, “only B”, “only C”, or “any combination of A, B, C”.

A slash (/) or comma used in the present specification may mean “and/or”. For example, “A/B” may mean “A and/or B”. Accordingly, “A/B” may mean “only A”, “only B”, or “both A and B”. For example, “A, B, C” may mean “A, B, or C”.

In the present specification, “at least one of A and B” may mean “only A”, “only B”, or “both A and B”. In addition, in the present specification, the expression “at least one of A or B” or “at least one of A and/or B” may be interpreted as “at least one of A and B”.

In addition, in the present specification, “at least one of A, B, and C” may mean “only A”, “only B”, “only C”, or “any combination of A, B. and C”. In addition, “at least one of A, B, or C” or “at least one of A, B, and/or C” may mean “at least one of A, B, and C”.

Technical features described individually in one figure in the present specification may be individually implemented, or may be simultaneously implemented.

The following example of the present specification may be applied to various wireless communication systems. For example, the following example of the present specification may be applied to a wireless local area network (WLAN) system. For example, the present specification may be applied to the IEEE 802.11ad standard or the IEEE 802.11ay standard. In addition, the present specification may also be applied to the newly proposed WLAN sensing standard or IEEE 802.11bf standard.

Hereinafter, in order to describe a technical feature of the present specification, a technical feature applicable to the present specification will be described.

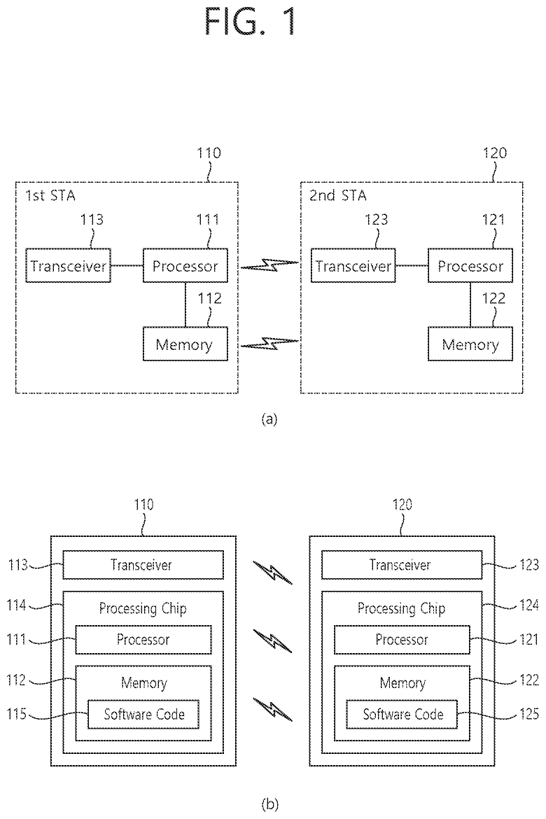

FIG. 1 shows an example of a transmitting apparatus and/or receiving apparatus of the present specification.

In the example of FIG. 1, various technical features described below may be performed. FIG. 1 relates to at least one station (STA). For example, STAs 110 and 120 of the present specification may also be called in various terms such as a mobile terminal, a wireless device, a wireless transmit/receive unit (WTRU), a user equipment (UE), a mobile station (MS), a mobile subscriber unit, or simply a user. The STAs 110 and 120 of the present specification may also be called in various terms such as a network, a base station, a node-B, an access point (AP), a repeater, a router, a relay, or the like. The STAs 110 and 120 of the present specification may also be referred to as various names such as a receiving apparatus, a transmitting apparatus, a receiving STA, a transmitting STA, a receiving device, a transmitting device, or the like.

For example, the STAs 110 and 120 may serve as an AP or a non-AP. That is, the STAs 110 and 120 of the present specification may serve as the AP and/or the non-AP.

STAs 110 and 120 of the present specification may support various communication standards together in addition to the IEEE 802.11 standard. For example, a communication standard (e.g., LTE, LTE-A, 5G NR standard) or the like based on the 3GPP standard may be supported. In addition, the STA of the present specification may be implemented as various devices such as a mobile phone, a vehicle, a personal computer, or the like. In addition, the STA of the present specification may support communication for various communication services such as voice calls, video calls, data communication, and self-driving (autonomous-driving), or the like.

The STAs 110 and 120 of the present specification may include a medium access control (MAC) conforming to the IEEE 802.11 standard and a physical layer interface for a radio medium.

The STAs 110 and 120 will be described below with reference to a sub-figure (a) of FIG. 1.

The first STA 110 may include a processor 111, a memory 112, and a transceiver 113. The illustrated process, memory, and transceiver may be implemented individually as separate chips, or at least two blocks/functions may be implemented through a single chip.

The transceiver 113 of the first STA performs a signal transmission/reception operation. Specifically, an IEEE 802.11 packet (e.g., IEEE 802.11a/b/g/n/ac/ax/be, etc.) may be transmitted/received.

For example, the first STA 110 may perform an operation intended by an AP. For example, the processor 111 of the AP may receive a signal through the transceiver 113, process a reception (RX) signal, generate a transmission (TX) signal, and provide control for signal transmission. The memory 112 of the AP may store a signal (e.g., RX signal) received through the transceiver 113, and may store a signal (e.g., TX signal) to be transmitted through the transceiver.

For example, the second STA 120 may perform an operation intended by a non-AP STA. For example, a transceiver 123 of a non-AP performs a signal transmission/reception operation. Specifically, an IEEE 802.11 packet (e.g., IEEE 802.11a/b/g/n/ac/ax/be packet, etc.) may be transmitted/received.

For example, a processor 121 of the non-AP STA may receive a signal through the transceiver 123, process an RX signal, generate a TX signal, and provide control for signal transmission. A memory 122 of the non-AP STA may store a signal (e.g., RX signal) received through the transceiver 123, and may store a signal (e.g., TX signal) to be transmitted through the transceiver.

For example, an operation of a device indicated as an AP in the specification described below may be performed in the first STA 110 or the second STA 120. For example, if the first STA 110 is the AP, the operation of the device indicated as the AP may be controlled by the processor 111 of the first STA 110, and a related signal may be transmitted or received through the transceiver 113 controlled by the processor 111 of the first STA 110. In addition, control information related to the operation of the AP or a TX/RX signal of the AP may be stored in the memory 112 of the first STA 110. In addition, if the second STA 120 is the AP, the operation of the device indicated as the AP may be controlled by the processor 121 of the second STA 120, and a related signal may be transmitted or received through the transceiver 123 controlled by the processor 121 of the second STA 120. In addition, control information related to the operation of the AP or a TX/RX signal of the AP may be stored in the memory 122 of the second STA 120.

For example, in the specification described below, an operation of a device indicated as a non-AP (or user-STA) may be performed in the first STA 110 or the second STA 120. For example, if the second STA 120 is the non-AP, the operation of the device indicated as the non-AP may be controlled by the processor 121 of the second STA 120, and a related signal may be transmitted or received through the transceiver 123 controlled by the processor 121 of the second STA 120. In addition, control information related to the operation of the non-AP or a TX/RX signal of the non-AP may be stored in the memory 122 of the second STA 120. For example, if the first STA 110 is the non-AP, the operation of the device indicated as the non-AP may be controlled by the processor 111 of the first STA 110, and a related signal may be transmitted or received through the transceiver 113 controlled by the processor 111 of the first STA 110. In addition, control information related to the operation of the non-AP or a TX/RX signal of the non-AP may be stored in the memory 112 of the first STA 110.

In the specification described below, a device called a (transmitting/receiving) STA, a first STA, a second STA, a STA1, a STA2, an AP, a first AP, a second AP, an AP1, an AP2, a (transmitting/receiving) terminal, a (transmitting/receiving) device, a (transmitting/receiving) apparatus, a network, or the like may imply the STAs 110 and 120 of FIG. 1. For example, a device indicated as, without a specific reference numeral, the (transmitting/receiving) STA, the first STA, the second STA, the STA1, the STA2, the AP, the first AP, the second AP, the AP1, the AP2, the (transmitting/receiving) terminal, the (transmitting/receiving) device, the (transmitting/receiving) apparatus, the network, or the like may imply the STAs 110 and 120 of FIG. 1. For example, in the following example, an operation in which various STAs transmit/receive a signal (e.g., a PPDU) may be performed in the transceivers 113 and 123 of FIG. 1. In addition, in the following example, an operation in which various STAs generate a TX/RX signal or perform data processing and computation in advance for the TX/RX signal may be performed in the processors 111 and 121 of FIG. 1. For example, an example of an operation for generating the TX/RX signal or performing the data processing and computation in advance may include: 1) an operation of determining/obtaining/configuring/computing/decoding/encoding bit information of a sub-field (SIG, STF, LTF, Data) included in a PPDU; 2) an operation of determining/configuring/obtaining a time resource or frequency resource (e.g., a subcarrier resource) or the like used for the sub-field (SIG, STF, LTF, Data) included the PPDU; 3) an operation of determining/configuring/obtaining a specific sequence (e.g., a pilot sequence, an STF/LTF sequence, an extra sequence applied to SIG) or the like used for the sub-field (SIG, STF, LTF, Data) field included in the PPDU; 4) a power control operation and/or power saving operation applied for the STA; and 5) an operation related to determining/obtaining/configuring/decoding/encoding or the like of an ACK signal. In addition, in the following example, a variety of information used by various STAs for determining/obtaining/configuring/computing/decoding/decoding a TX/RX signal (e.g., information related to a field/subfield/control field/parameter/power or the like) may be stored in the memories 112 and 122 of FIG. 1.

The aforementioned device/STA of the sub-figure (a) of FIG. 1 may be modified as shown in the sub-figure (b) of FIG. 1. Hereinafter, the STAs 110 and 120 of the present specification will be described based on the sub-figure (b) of FIG. 1.

For example, the transceivers 113 and 123 illustrated in the sub-figure (b) of FIG. 1 may perform the same function as the aforementioned transceiver illustrated in the sub-figure (a) of FIG. 1. For example, processing chips 114 and 124 illustrated in the sub-figure (b) of FIG. 1 may include the processors 111 and 121 and the memories 112 and 122. The processors 111 and 121 and memories 112 and 122 illustrated in the sub-figure (b) of FIG. 1 may perform the same function as the aforementioned processors 111 and 121 and memories 112 and 122 illustrated in the sub-figure (a) of FIG. 1.

A mobile terminal, a wireless device, a wireless transmit/receive unit (WTRU), a user equipment (UE), a mobile station (MS), a mobile subscriber unit, a user, a user STA, a network, a base station, a Node-B, an access point (AP), a repeater, a router, a relay, a receiving unit, a transmitting unit, a receiving STA, a transmitting STA, a receiving device, a transmitting device, a receiving apparatus, and/or a transmitting apparatus, which are described below, may imply the STAs 110 and 120 illustrated in the sub-figure (a)/(b) of FIG. 1, or may imply the processing chips 114 and 124 illustrated in the sub-figure (b) of FIG. 1. That is, a technical feature of the present specification may be performed in the STAs 110 and 120 illustrated in the sub-figure (a)/(b) of FIG. 1, or may be performed only in the processing chips 114 and 124 illustrated in the sub-figure (b) of FIG. 1. For example, a technical feature in which the transmitting STA transmits a control signal may be understood as a technical feature in which a control signal generated in the processors 111 and 121 illustrated in the sub-figure (a)/(b) of FIG. 1 is transmitted through the transceivers 113 and 123 illustrated in the sub-figure (a)/(b) of FIG. 1. Alternatively, the technical feature in which the transmitting STA transmits the control signal may be understood as a technical feature in which the control signal to be transferred to the transceivers 113 and 123 is generated in the processing chips 114 and 124 illustrated in the sub-figure (b) of FIG. 1.

For example, a technical feature m which the receiving STA receives the control signal may be understood as a technical feature in which the control signal is received by means of the transceivers 113 and 123 illustrated in the sub-figure (a) of FIG. 1. Alternatively, the technical feature in which the receiving STA receives the control signal may be understood as the technical feature in which the control signal received in the transceivers 113 and 123 illustrated in the sub-figure (a) of FIG. 1 is obtained by the processors 111 and 121 illustrated in the sub-figure (a) of FIG. 1. Alternatively, the technical feature in which the receiving STA receives the control signal may be understood as the technical feature in which the control signal received in the transceivers 113 and 123 illustrated in the sub-figure (b) of FIG. 1 is obtained by the processing chips 114 and 124 illustrated in the sub-figure (b) of FIG. 1.

Referring to the sub-figure (b) of FIG. 1, software codes 115 and 125 may be included in the memories 112 and 122. The software codes 115 and 126 may include instructions for controlling an operation of the processors 111 and 121. The software codes 115 and 125 may be included as various programming languages.

The processors 111 and 121 or processing chips 114 and 124 of FIG. 1 may include an application-specific integrated circuit (ASIC), other chipsets, a logic circuit and/or a data processing device. The processor may be an application processor (AP). For example, the processors 111 and 121 or processing chips 114 and 124 of FIG. 1 may include at least one of a digital signal processor (DSP), a central processing unit (CPU), a graphics processing unit (GPU), and a modulator and demodulator (modem). For example, the processors 111 and 121 or processing chips 114 and 124 of FIG. 1 may be SNAPDRAGON™ series of processors made by Qualcomm®, EXYNOS™ series of processors made by Samsung®, A series of processors made by Apple®, HELIO™ series of processors made by MediaTek®, ATOM™ series of processors made by Intel® or processors enhanced from these processors.

In the present specification, an uplink may mean a link for communication from a non-AP STA to an AP STA, and an uplink PPDU/packet/signal or the like may be transmitted through the uplink. In addition, in the present specification, a downlink may mean a link for communication from the AP STA to the non-AP STA, and a downlink PPDU/packet/signal or the like may be transmitted through the downlink.

A WLAN sensing technology is a sort of radar technologies which can be implemented without a standard, but it is conceived that more powerful performance can be obtained through standardization. The IEEE 802.11bf standard defines an apparatus participating in wireless LAN sensing for each function as shown in the following table. According to the function thereof, the apparatus may be classified into an apparatus initiating WLAN sensing and an apparatus participating in the sensing, an apparatus transmitting a sensing physical layer protocol data unit (PPDU) and an apparatus receiving the PPDU.

TABLE 1

| Terminology | Function |
|---|---|
| Sensing Initiator | apparatus initiating sensing |
| Sensing Responder | apparatus participating in sensing |
| Sensing Transmitter | apparatus transmitting sensing PPDU |
| Sensing Receiver | apparatus receiving sensing PPDU |

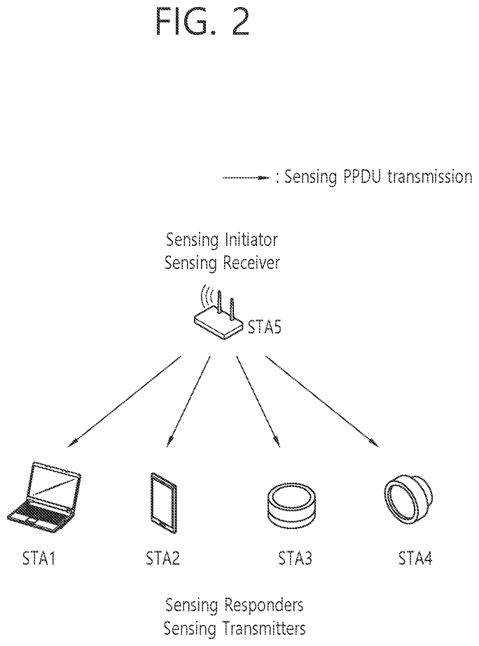

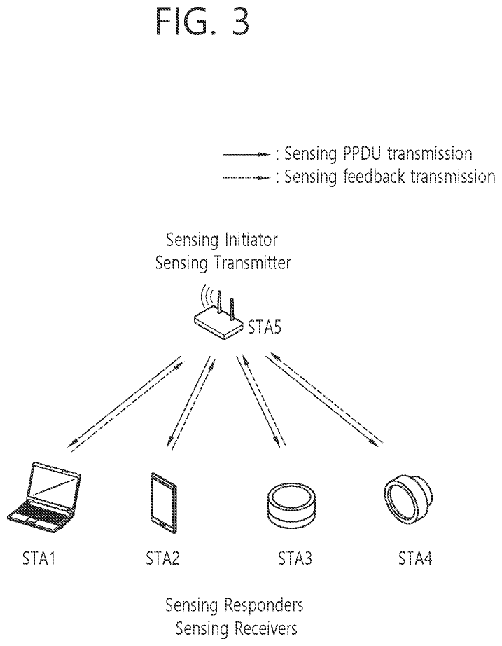

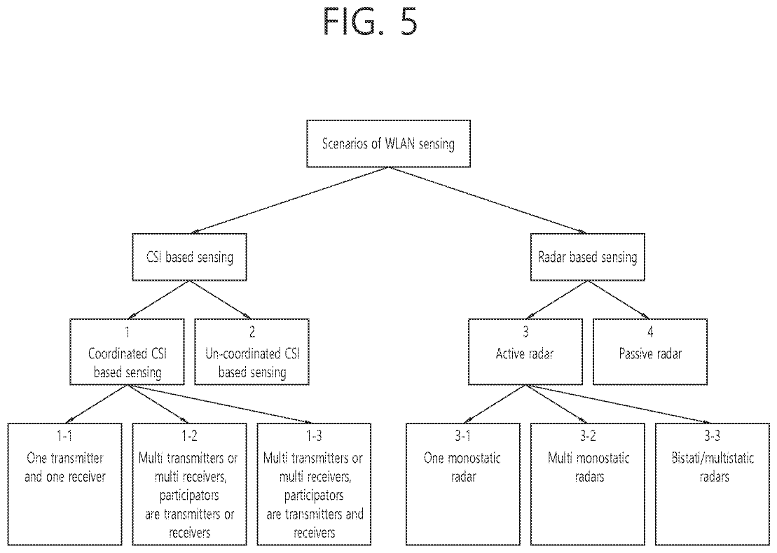

FIG. 2 illustrates an example of a WLAN sensing scenario using multiple sensing transmitting apparatuses. FIG. 3 illustrates an example of a WLAN sensing scenario using multiple sensing receiving apparatuses. FIG. 2 and FIG. 3 illustrate a sensing scenario based on a function and deployment of a WLAN sensing apparatus. In an environment assuming one sensing initiation apparatus and multiple sensing participating apparatuses, FIG. 2 is a scenario using multiple sensing PPDU transmitting apparatuses, and FIG. 3 is a scenario using multiple sensing PPDU receiving apparatuses. Assuming that the sensing PPDU receiving apparatus includes a sensing measurement signal processing apparatus, in case of FIG. 3, a procedure for transmitting (feeding back) a sensing measurement result to the sensing initiation apparatus (STA 5) is additionally required. A procedure of WLAN sensing is performed as discovery, negotiation, measurement exchange, tear down, or the like between WLAN sensing initiation apparatus and participating apparatuses. The discovery is a process of identifying sensing capability of WLAN apparatuses. The negotiation is a process of determining a sensing parameter between the sensing initiation apparatus and participating apparatus. The measurement exchange is a process of transmitting a sensing PPDU and transmitting a sensing measurement result. The tear down is a process of terminating the sensing procedure. FIG. 5 is an example of classifying WLAN sensing.

The WLAN sensing may be classified into CSI-based sensing which uses channel state information of a signal arrived at a receiver through a channel and radar-based sensing which uses a signal received after a transmission signal is reflected by an object. In addition, each sensing technology is classified again into a scheme (a coordinated CSI, active radar) in which a sensing transmitter directly participates in a sensing process and a scheme (un-coordinated CSI, passive radar) in which the sensing transmitter does not participate in the sensing process, i.e., there is no dedicated transmitter participating in the sensing process.

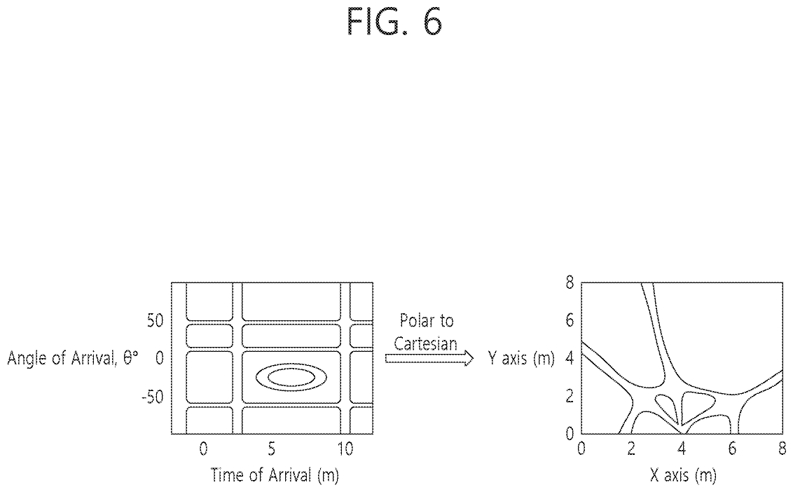

FIG. 6 illustrates indoor positioning which uses CSI-based WLAN sensing.

In FIG. 6, the CSI-based WLAN sensing is utilized in the indoor positioning. An angle of arrival and a time of arrival are obtained by using CSI, and then are converted into an orthogonal coordinate to obtain indoor positioning information.

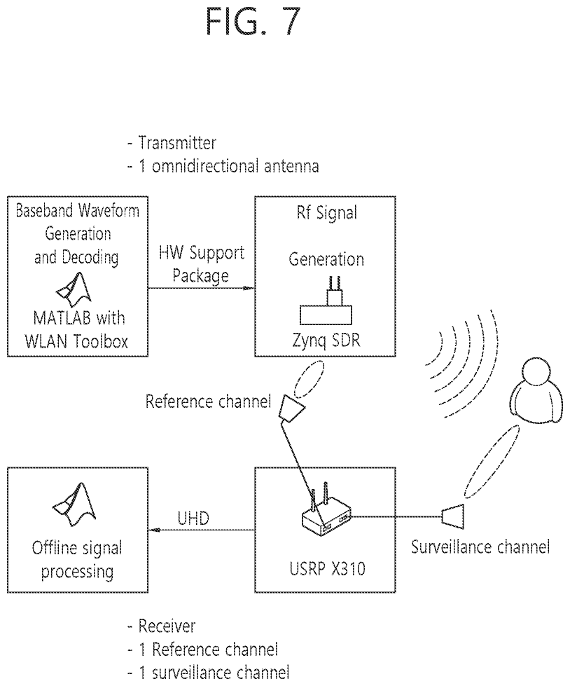

FIG. 7 is an example of implementing a WLAN sensing apparatus.

In FIG. 7, the WLAN sensing apparatus is implemented using a MATLAB toolbox, Zynq, and USRP. An IEEE 802.11ax WLAN signal is generated in the MATLAB toolbox, and an RF signal is generated using a Zynq software defined radio (SDR). A signal passing through a channel is received using a USRP SDR, and sensing signal processing is performed in the MATLAB toolbox. Herein, one reference channel (a channel which can be directly received from a sensing transmitter) and one surveillance channel (a channel which can be received by being reflected by an object) are assumed. As a result of analysis using the WLAN sensing apparatus, it is possible to obtain a unique feature capable of identifying a motion or a body action.

The IEEE 802.11bf WLAN sensing standardization is in an initial stage of development at present, and it is expected that a cooperative sensing technology for improving sensing accuracy will be treated to be important in the future. It is expected that a synchronization technology of a sensing signal for cooperative sensing, a CSI management and usage technology, a sensing parameter negotiation and sharing technology, a scheduling technology for CSI generation, or the like will be a core subject for standardization. In addition, it is also expected that a long-distance sensing technology, a low-power sensing technology, a sensing security and privacy protection technology, or the like will be reviewed as a main agenda.

IEEE 802.11bf WLAN sensing is a sort of radar technologies using a WLAN signal which exists any where anytime. The following table shows a typical case of using IEEE 802.11bf, which may be utilized in a wide range of daily life such as indoor detection, motion recognition, health care, 3D vision, in-vehicle detection, or the like. Since it is mainly used indoors, an operating range is usually within 10 to 20 meters, and distance accuracy does not exceed up to 2 meters.

TABLE 2

| | | Max | Key | Range | Max Velocity | angular |
|---|---|---|---|---|---|---|
| | | range | Performance | Accuracy | (m/s)/Velocity | Accuracy |
| Name | details | (m) | Indicator | (m) | Accuracy | (deg) |
| Room Sensing | presence detection, | 15 | Number of | 0.5-2 | 2/0.1 | |
| | counting the number of | | Persons in Room | | | |
| | people in the room | | | | | |
| Smart meeting room | presence detection, | 10 | Location of | 0.5-2 | 1/0.1-0.3 | |
| | counting the number of | | persons in room | | | |
| | people in the room, | | | | | |
| | localization of active | | | | | |
| | people | | | | | |
| Motion detection | Detection of motion of | 10 | | | | |
| in a room | in a room (of Human) | | | | | |
| Home security | Detection of presence | 10 | Detection of a | 0.5-2 | 3/0.1-0.3 | medium |
| | of intruders in a home | | person in a room | | | |
| Audio with user | Tracking persons | 6 | Localization | 0.2 | 0.5/0.05 | 3 |
| tracking | in a room and pointing | | of persons to | | | |
| | the sound of an audio | | within 0.2 m | | | |
| | system at those people | | | | | |
| Store Sensing | Counting number of people | 20 | Number and | 0.5-2 | 1/0.1-0.3 | 3 |
| | in a store, their location, | | location of | | | |
| | speed of movement. | | persons in | | | |
| | Accuracy less important | | store | | | |
| Home Appliance | Tracking person and motion/ | 10 | Gesture | <1 | | |
| Control | gesture detection | | Detection | | | |
| Gesture recognition - short | Identification of a gesture | 0.5 | Gesture | | 7 | 3 |
| range (finger movement) | from a set of gestures - | | Detection | | | |
| | range <0.5 m | | | | | |
| Gesture recognition - | Identification of a gesture | 2 | Gesture | | | |
| medium range (hand | from a set of gestures - | | Detection | | | |
| movement) | range >0.5 m | | | | | |
| Gesture recognition - | Identification of a gesture | 7 | Gesture | 0.2 | 2/0.1 | 5 |
| large range (full body | from a set of gestures - | | Detection | | | |
| movement) | range >2 m | | | | | |
| Aliveliness detection | Determination whether a close | 1 | Aliveliness | 0.05 | | |
| | by object is alive or not | | Detection | | | |
| Face/Body Recognition | Selection of the identity of | 1 | Identity | 0.02 | | |
| | a person from a set of known | | detection | | | |
| | persons | | | | | |
| Proximity Detection | Detection of object in close | 0.5 | Object | 0.02-2 | 1.5/0.2 | none |
| | proximity of device | | Detection | | | |
| Home Appliance | Gesture Detection | 3 | Gesture | <1 | 3/0.1 | |
| Control | | | Detection | | | |
| health care - Fall | Fall detection - abnormal | 10 | | 0.2 | 3/0.1 | |
| detection | position detection | | | | | |
| Health case - remote | measurements of breathing rate, | 5 | Breathing rate | 0.5 | 2/0.1 | |
| diagnostics | heart rate etc. | | accuracy/Pulse | | | |
| | | | Accuracy | | | |
| Surveillance/Monitoring | Tracking person and presence | 10 | Detection and | 0.2-2 | 3/0.1 | |
| of elder people and/or | detection | | localization | | | |
| children | | | of person | | | |
| Sneeze sensing | Detecting and localizing the | 10 | Detection and | 0.2-0.5 | 20/0.1 | |
| | target human and sneeze | | localization of | | | |
| | droplet volume | | person and sneeze | | | |
| | | | droplet volume | | | |
| 3d vision | building a 3d picture of an | 10 | accuracy of 3d map | 0.01 | 5/0.1 | 2 |
| | environment, using multiple STA | | (range, angle) | | | |
| In car sensing - | detection of humans in car | 5 | Presence of | 0.1 | 1/0.1 | 3 |
| detection | | | Human in car | | | |
| In car sensing | Driver sleepiness detection/ | 3 | Fast detection | 0.01 | 1/0.1 | 3 |
| | detection aid | | of driver sleepiness | | | |

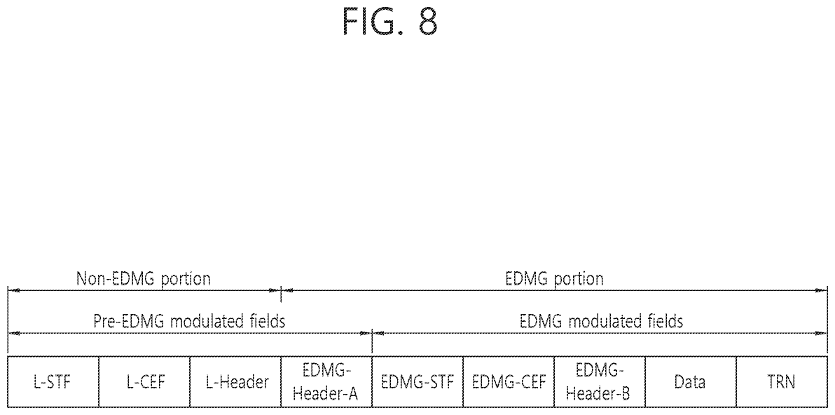

In IEEE 802.11, there is ongoing discussion on a technology for sensing a motion or gesture of an object (person or thing) using a Wi-Fi signal of 60 GHz (e.g., 802.11ad or 802.11ay signal). The present specification proposes a method of configuring a frame format used for Wi-Fi sensing and a Wi-Fi sensing sequence. FIG. 8 briefly illustrates a PPDU structure supported in an 802.111ay WLAN system. As shown in FIG. 8, the PPDU format applicable to the 11ay system may include L-STF, L-CEF, L-Header, EDMG-Header-A, EDMG-STF, EDMG-CEF. EDMG-Header-B, Data, and TRN fields, and the aforementioned fields may be selectively included in accordance with the format of the PPDU (e.g., SU PPDU, MU PPDU, etc.). Herein, a portion including the L-STF. L-CEF, and L-header fields may be referred to as a non-EDMG portion, and the remaining portion may be referred to as an EDMG portion. Additionally, the L-STF, L-CEF. L-Header, and EDMG-Header-A fields may be referred to as pre-EDMG modulated fields, and the remaining portions may be referred to as EDMG modulated fields. The EDMG-Header-A field includes information required to demodulate an EDMG PPDU. The definition of the EDMG-Header-A field is the same as those of the EDMG SC mode PPDU and the EDMG OFDM mode PPDU, but is different from the definition of the EDMG control mode PPDU.

A structure of EDMG-STF depends on the number of consecutive 2.16 GHz channels through which the EDMG PPDU is transmitted and an index i_{STS} of an i_{STS}-th space-time stream. For single space-time stream EDMG PPDU transmission using an EDMG SC mode through one 2.16 GHz channel, an EDMG-STF field does not exist. For EDMG SC transmission, the EDMG-STF field shall be modulated using pi/(2-BPSK).

A (legacy) preamble part of the PPDU may be used for packet detection, automatic gain control (AGC), frequency offset estimation, synchronization, indication of modulation (SC or OFDM) and channel estimation. A format of the preamble may be common to both an OFDM packet and an SC packet. In this case, the preamble may be constructed of a short training field (STF) and a channel estimation (CE) field located after the STF field.

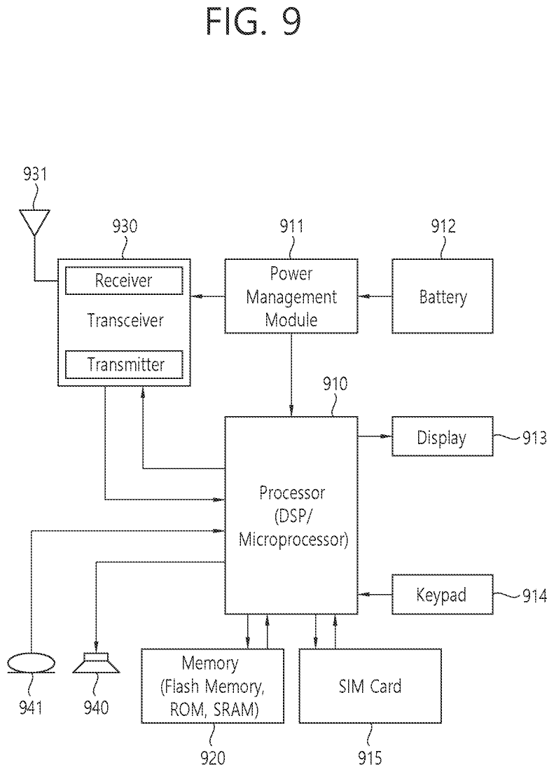

FIG. 9 illustrates an example of a modified transmitting apparatus and/or receiving apparatus of the present specification.

Each apparatus/STA of the sub-figure (a)/(b) of FIG. 1 may be modified as shown in FIG. 9. A transceiver 930 of FIG. 9 may be identical to the transceivers 113 and 123 of FIG. 1. The transceiver 930 of FIG. 9 may include a receiver and a transmitter.

A processor 910 of FIG. 9 may be identical to the processors 111 and 121 of FIG. 1. Alternatively, the processor 910 of FIG. 9 may be identical to the processing chips 114 and 124 of FIG. 1.

A memory 920 of FIG. 9 may be identical to the memories 112 and 122 of FIG. 1. Alternatively, the memory 920 of FIG. 9 may be a separate external memory different from the memories 112 and 122 of FIG. 1.

Referring to FIG. 9, a power management module 911 manages power for the processor 910 and/or the transceiver 930. A battery 912 supplies power to the power management module 911. A display 913 outputs a result processed by the processor 910. A keypad 914 receives inputs to be used by the processor 910. The keypad 914 may be displayed on the display 913. A SIM card 915 may be an integrated circuit which is used to securely store an international mobile subscriber identity (IMSI) and its related key, which are used to identify and authenticate subscribers on mobile telephony apparatuses such as mobile phones and computers.

Referring to FIG. 9, a speaker 940 may output a result related to a sound processed by the processor 910. A microphone 941 may receive an input related to a sound to be used by the processor 910.

In IEEE802.11bf, an 802.11ad and 802.11ay signal transmitting/receiving method which is a 60 GHz Wi-Fi technology is considered to sense a motion or gesture of a STA or person by using a 60 GHz Wi-Fi signal. For effective Wi-Fi sensing, the present specification proposes a method of configuring a sensing initiation frame, a transmission initiation frame, and a sensing signal, and a sensing sequence for transmitting/receiving the sensing initiation frame, the transmission initiation frame, and the sensing signal.

A STA described in the following description may be the apparatus of FIG. 1 and/or FIG. 9, and a PPDU may be the PPDU of FIG. 7. A device may be an AP or a non-AP STA.

A wireless local area network (WLAN) has been introduced for the purpose of short-distance data transmission using an unlicensed band. An IEEE 802.11 MAC/PHY-based WLAN (e.g. Wi-Fi) has become a representative technology which is at present deployed almost everywhere.

The WLAN (e.g., Wi-Fi) has been designed for data signal transmission, but a usage thereof has recently been extended for other purposes than data transmission.

A WLAN (e.g., Wi-Fi) signal transmitted from a transmitting end and delivered to a receiving end may include information on a transmission channel environment between both the transmitting and receiving ends. WLAN sensing refers to a technology which obtains recognition information for various surrounding environments by processing the transmission channel information obtained through the WLAN signal.

For example, cognitive information may include information obtained through a technology such as gesture recognition, fall detection by elder people, intrusion detection, human motion detection, health monitoring, pet movement detection, or the like.

An additional service may be provided through the recognition information, and WLAN sensing may be applied and used in various forms in daily life. As a method for increasing accuracy of WLAN sensing, devices having at least one WLAN sensing function may be used in the WLAN sensing. The WLAN sensing using the plurality of devices may use multiple pieces of information for a channel environment, and thus may obtain more accurate sensing information, compared to a method of using one device (e.g. a transmitting/receiving end).

WLAN sensing can be classified into the following two methods according to the feedback method of sensing information:

Explicit feedback-based method: the initiator transmits a signal for sensing, and the responder(s) can transmit the sensed channel information or the result of sensing to the initiator. The initiator may derive a sensing result based on channel information obtained from the responder(s).

Implicit feedback-based method: the responder(s) transmits signals for sensing, and the initiator estimates a channel using the signals and derives the sensing result based on it.

Explicit/implicit feedback methods each have the following advantages and disadvantages in terms of overhead:

Explicit feedback: Sensing by one or more responders is possible through one broadcast. Overhead can occur due to explicit feedback from responders.

Implicit feedback: Feedback overhead by responders can be reduced. Overhead can occur to coordinate feedback from one or more responders.

The present specification proposes a method of flexibly supporting each of the two methods of Explicit/Implicit in WLAN Sensing or simultaneously supporting them.

Roles performed by STAs in WLAN sensing may be as follows.

WLAN Sensing Initiator: A station (STA) that instructs devices having one or more sensing functions (i.e., WLAN Sensing responder) to initiate a Sensing Session using a WLAN signal. The WLAN Sensing initiator may send a signal for sensing or may request signal transmission for sensing from other STAs.

WLAN Sensing Responder: A station (STA) that can participate in WLAN Sensing at the direction of the WLAN Sensing initiator and perform the instructed sensing, deliver signals to the initiator, or transmit signals for sensing at the direction of the initiator.

Sensing initiator can transmit information related to a specific band, bandwidth, and number of transmissions used when transmitting sensing signals to sensing responders. Signals for sensing (i.e., sensing signals) may be transmitted from sensing responders to sensing initiators.

Sensing responders may use a new frame or an existing frame for signal transmission. For example, a Null Data Packet (NDP) frame defined in an existing WLAN (e.g., Wi-Fi) may be used as a sensing signal.

Sensing responders may inform parameters applied to the signal frame before transmitting the signal transmission frame. These parameters may contain information related to the state of the current Sensing responder that the Sensing initiator does not know about. For example, the sensing responder STA may transmit information related to transmission power according to available power, how many antennas are used when one or more antennas are provided, and how many spatial streams are used for transmission, etc. to the sensing initiator STA.

State information of the sensing responder can be transmitted through a new frame or an existing frame. For example, state information of a sensing responder may be transmitted to a sensing initiator through a Null Data Packet Announcement (NDPA) frame. That is, the NDPA frame may include state information of the sensing responder.

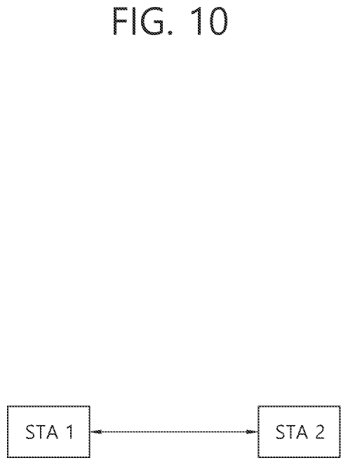

FIG. 10 is a diagram illustrating an embodiment of a connection form of WLAN sensing devices (i.e., stations).

Referring to FIG. 10, for example, WLAN sensing devices (i.e., STAs) may be connected in a point-to-point (P2P) format. The double-headed arrow indicates that information can be exchanged. That is, STA 1 and STA 2 can transmit and receive each other.

Phase 1: Initiation Stage

The WLAN Sensing initiator may transmit a sensing initiation frame for initiation of sensing. The sensing initiation frame may include information on a STA participating in sensing as a responder (e.g., AID, STA ID, etc.), sensing duration, number of times of sensing, feedback method, frequency of feedback, and information related to sensing information and feedback.

Sensing duration may be a TXOP duration obtained by the initiator. During the TXOP duration, the initiator and responder may perform one or more sensing sessions. Each sensing session can support explicit or implicit feedback. For example, the sensing session may include transmitting a sensing signal (e.g., an NDP frame) and transmitting feedback for the sensing signal. For example, the sensing duration may include at least one TXOP.

For example, the feedback method can be specified in explicit, implicit, or hybrid form by an indicator. For example, a signal for initiating sensing transmitted by an initiator (i.e., a sensing initiation frame) may include a 2-bit indicator, and a feedback method may be determined using the 2-bit indicator. For example, a 2-bit indicator may have values such as “00” (explicit feedback), “01” (implicit feedback), “10” (hybrid feedback), and “11” (reserved). That is, the sensing initiation frame may include information related to a feedback method, and the feedback method may be determined as at least one of explicit feedback, implicit feedback, and hybrid feedback.

The number of sensing may indicate the total number of sensing sessions to be performed during the TXOP Duration. For example, if the feedback method is designated as “00” (explicit feedback) and the number of sensing is designated as 5, this may mean that explicit feedback-based sensing is performed 5 times during TXOP (or sensing session).

For example, when the sensing feedback method is designated as hybrid (example “10” above), explicit and implicit feedback count information can be provided through additional information. For example, when the feedback method is a hybrid method, the sensing initiation frame may further include additional information necessary for performing the hybrid method.

The feedback frequency may include information on whether to transmit feedback for every session or after a specific session.

A sensing initiation frame that initiates a WLAN sensing session may use an existing frame (e.g., Null Data Packet Announcement (NDPA)) or a new frame. NDPA or new frame may include an indicator indicating that the purpose is WLAN Sensing.

Phase 2-1: Sensing Stage (Explicit Feedback)

The WLAN sensing initiator may transmit a sensing frame used for sensing to a responder at a predetermined time after transmission of the sensing initiation frame.

The sensing frame may be defined as a new frame, or an existing frame may be used as the sensing frame. For example, an existing Null-Data Packet (NDP) frame may be used as a sensing frame.

For example, since Phase 2-1 is an embodiment related to the explicit feedback method, the feedback method included in the sensing initiation frame may be “00”. That is, the sensing initiation frame may include information related to an explicit feedback method.

Feedback may proceed according to the number of feedback frequencies included in the sensing initiation frame. For example, the feedback frequency information may include information related to whether feedback is performed for each sensing session or whether feedback is performed after the last sensing session. For example, the feedback frequency information may include a 2-bit indicator, and the 2-bit indicators may be set to one of “00” (feedback per session), “01” (feedback after last session), “10” (other), and “11” (reserved).

For example, when sensing feedback is set to be performed for each sensing session (e.g., “00”), the responder may transmit feedback after transmission of every sensing frame (e.g., NDP). Feedback may be requested by the initiator (e.g., feedback request signal transmission), or the responder may transmit feedback to the initiator after a specific time (e.g., Short Inter-Frame Space (SIFS)).

If sensing feedback is set to be performed after the last sensing session (e.g., “01”), the responder may transmit feedback after all sensing frames (e.g., NDP) are transmitted. Feedback may be channel measurement information for each sensing frame (e.g., NDP) or average channel measurement information for all sensing frames. Channel measurement can be performed according to the measurement granularity specified in the sensing start frame. That is, the sensing frame may include information related to measurement granularity. For example, measurement granularity may include information related to a subcarrier unit in which channel estimation is performed. Feedback may be requested by the initiator (e.g., feedback request signal transmission), or the responder may transmit feedback to the initiator after a specific time (e.g., Short Inter-Frame Space (SIFS)).

For example, if sensing feedback is set to be performed after transmission of a specific number of sensing frames (e.g., “10”), the responder may transmit feedback after transmission of a specific number of sensing frames by an initiator. Information on a specific number of times may be additionally included in the session initiation frame. Feedback may be channel measurement information for a specific number of NDPs or average channel measurement information for a specific number of NDP transmissions. For example, channel measurement can be performed according to the measurement granularity specified in the sensing initiation frame. Feedback may be requested by the initiator (e.g., feedback request signal transmission), or the responder may transmit feedback to the initiator after a specific time (e.g., Short Inter-Frame Space (SIFS)).

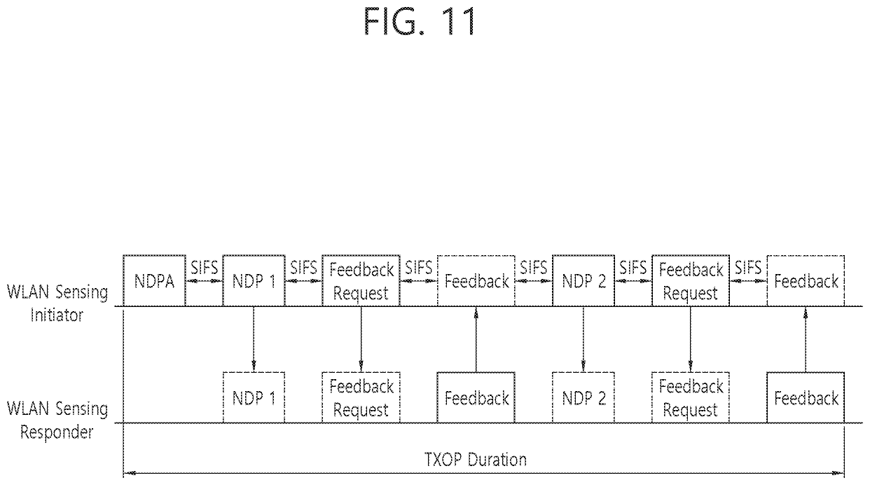

FIG. 11 is a diagram illustrating an embodiment of an explicit feedback operation method.

Referring to FIG. 11, the initiator may request channel measurement information from the responder every sensing frame (i.e., NDP frame) transmission.

For example, the initiator may transmit a sensing initiation frame, and may transmit a sensing frame (i.e., NDP1) after transmitting the sensing initiation frame. The initiator may transmit a feedback request frame after transmitting the sensing frame. When receiving the feedback request frame, the responder may transmit the feedback frame. The initiator may transmit a sensing frame (i.e., NDP2) again and may transmit a feedback request frame. The responder may receive the feedback request frame and may transmit the feedback frame.

An existing NDPA frame may be used as a sensing initiation frame, and an NDP frame may be used as a sensing frame. TXOP duration may include 2 or more sensing sessions. Here, the sensing session may include NDP transmission, feedback request transmission, and feedback transmission.

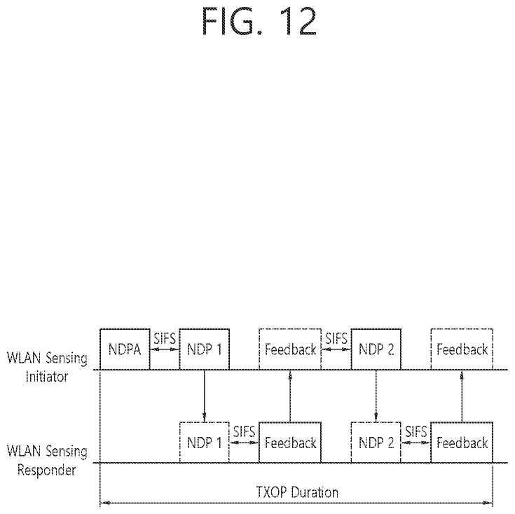

FIG. 12 is a diagram illustrating an embodiment of an explicit feedback operation method.

Referring to FIG. 12, for each sensing frame transmission, the responder may transmit Feedback to the initiator after a specific time (e.g., SIFS) after receiving the sensing frame.

For example, the initiator may transmit a sensing initiation frame (i.e., NDPA frame) and may transmit a sensing frame (i.e., NDP1). The responder may receive the sensing frame and may transmit a feedback frame. Thereafter, the initiator may transmit a sensing frame (i.e., NDP2). The responder may receive the sensing frame and may transmit a feedback frame.

An existing NDPA frame may be used as a sensing initiation frame, and an NDP frame may be used as a sensing frame. TXOP duration may include 2 or more sensing sessions. Here, the sensing session may include NDP transmission and feedback transmission.

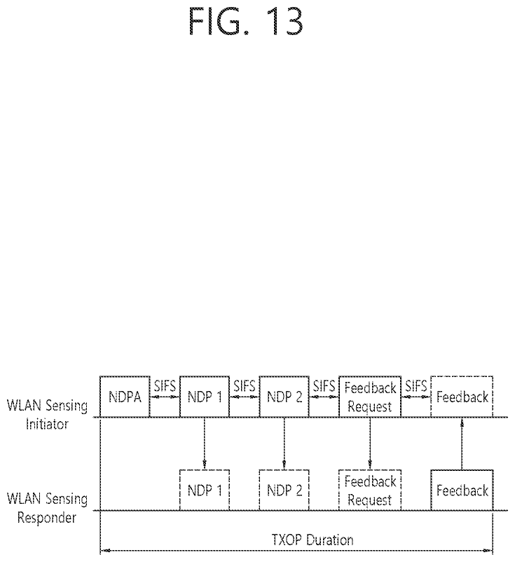

FIG. 13 is a diagram illustrating an embodiment of an explicit feedback operation method.

Referring to FIG. 13, the initiator may transmit a feedback request frame requesting channel measurement information to the responder after transmitting the last sensing frame.

For example, the initiator may transmit a sensing initiation frame (i.e., NDPA frame) and may continuously transmit a plurality of sensing frames (i.e., NDP1 and NDP2). The initiator may transmit a feedback request frame after transmitting the sensing frame. The responder may receive the feedback request frame and may transmit the feedback frame.

An existing NDPA frame may be used as a sensing initiation frame, and an NDP frame may be used as a sensing frame. TXOP duration may include 2 or more sensing sessions. Here, the sensing session may include a series of NDP transmission, feedback request transmission, and feedback transmission.

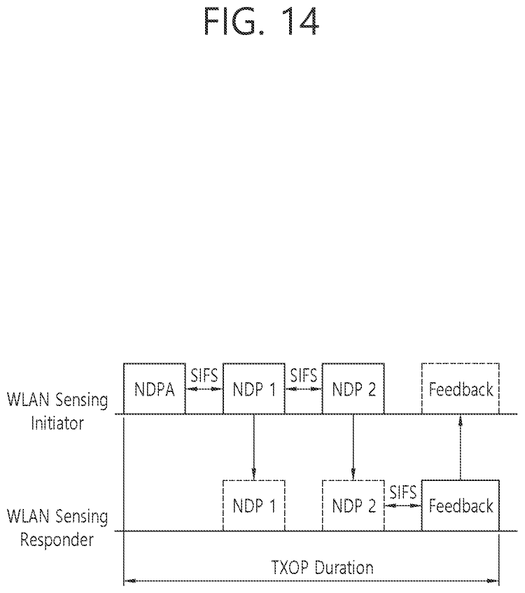

FIG. 14 is a diagram illustrating an embodiment of an explicit feedback operation method.

Referring to FIG. 14, the responder may transmit Feedback to the initiator after a specific time (e.g., SIFS) after receiving the last sensing frame.

For example, the initiator may transmit a sensing initiation frame (i.e., NDPA frame) and may transmit a plurality of sensing frames (i.e., NDP1 and NDP2). The responder may transmit a feedback frame after receiving the sensing frame.

An existing NDPA frame may be used as a sensing initiation frame, and an NDP frame may be used as a sensing frame. TXOP duration may include 2 or more sensing sessions. Here, the sensing session may include a series of NDP transmission and feedback transmission.

Phase 2-2: Sensing Stage (Implicit Feedback)

The WLAN sensing responder may transmit a sensing frame used for sensing to the initiator at a predetermined time after receiving the sensing initiation frame.

The sensing frame may be defined as a new frame, or an existing frame may be used as the sensing frame. For example, an existing Null-Data Packet (NDP) frame may be used as a sensing frame.

Prior to transmission of the sensing frame, transmission of a frame (e.g., sensing initiation frame) including information related to transmission of the sensing frame may be performed first.

For example, since Phase 2-2 is an embodiment related to the implicit feedback method, the feedback method included in the sensing initiation frame may be “01”. That is, the sensing initiation frame may include information related to the implicit feedback method.

Feedback may proceed according to the number of feedback frequencies included in the sensing initiation frame. For example, the feedback frequency information may include information related to whether feedback is performed for each sensing session or whether feedback is performed after the last sensing session. For example, the feedback frequency information may include a 2-bit indicator, and the 2-bit indicators may be set to one of “00” (feedback per session), “01” (feedback after last session), “10” (other), and “11” (reserved).

However, in the implicit feedback method, the responder only transmits the sensing frame (i.e., the NDP frame) to the initiator, and the feedback frame is not separately transmitted. Therefore, the number of feedback frequencies may have a different meaning from the above explicit feedback.

For example, when sensing feedback frequency information is set to “00”, after each NDP transmission by a responder, an initiator may transmit a sensing initiation frame after a specific time (e.g., SIFS).

For example, if sensing feedback frequency information is set to “01”, the responder can transmit NDP all times. All counts may be preset values in the sensing initiation frame or the like.

For example, if information on the number of feedback frequencies of sensing is set to “10”, the responder can continuously transmit sensing frames a specific number of times after receiving a sensing initiation frame. For example, information related to the number of consecutively transmitted sensing frames may be based on information included in a sensing initiation frame. For example, the sensing initiation frame may include information related to the number of transmissions of the sensing frame. Information about a specific number of times may be included in a sensing initiation frame from an initiator, or may be included in a frame transmitted by a responder prior to transmission of a sensing signal. That is, the number of transmissions of sensing frames may be set by the responder. After a specific number of transmissions by the responder, sensing is initiated through a sensing initiation frame by the initiator, or the responder can restart/re-initiate after a specific time.

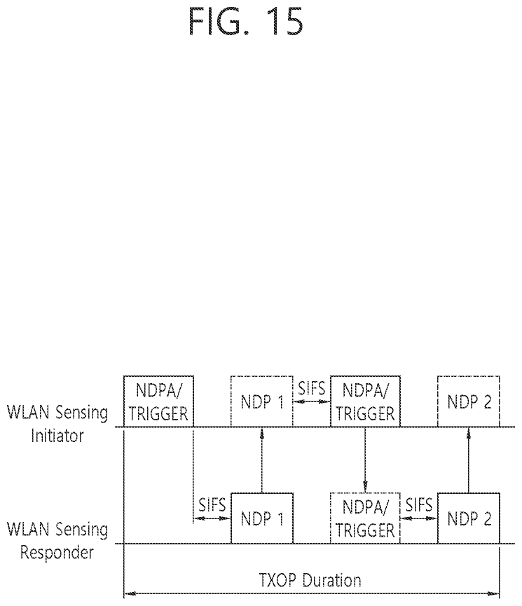

FIG. 15 is a diagram illustrating an embodiment of an implicit feedback operation method.

Referring to FIG. 15, an initiator may transmit a sensing initiation frame after a specific time (e.g., SIFS) after transmission of every sensing frame (i.e., NDP frame) by a responder.

For example, an initiator may transmit a sensing initiation frame (i.e., NDPA or trigger frame), and a responder receiving the sensing initiation frame may transmit a sensing frame (i.e., NDP1). The initiator may receive the sensing frame and transmit the sensing initiation frame to the responder again. Upon receiving the sensing initiation frame, the responder may transmit the sensing frame (i.e., NDP2) again.

An existing NDPA frame or a trigger frame may be used as a sensing initiation frame, and an NDP frame may be used as a sensing frame. TXOP duration may include 2 or more sensing sessions. Here, the sensing session may include NDPA/Trigger transmission and NDP transmission.

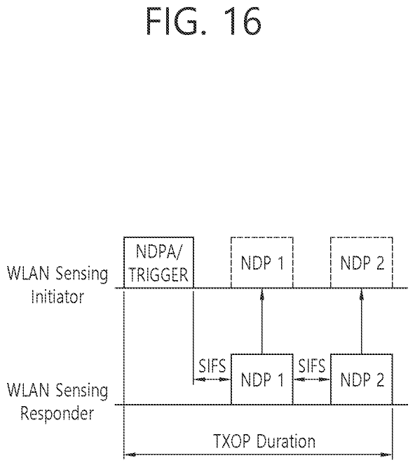

FIG. 16 is a diagram illustrating an embodiment of an implicit feedback operation method.

Referring to FIG. 16, the responder may transmit NDP all times.

For example, the initiator may transmit a sensing initiation frame (i.e., NDPA or Trigger frame). Upon receiving the sensing initiation frame, the responder may continuously transmit a series of sensing frames (i.e., NDP1 and NDP2).

An existing NDPA frame or a trigger frame may be used as a sensing initiation frame, and an NDP frame may be used as a sensing frame. TXOP duration may include 2 or more sensing sessions. Here, the sensing session may include NDP transmission.

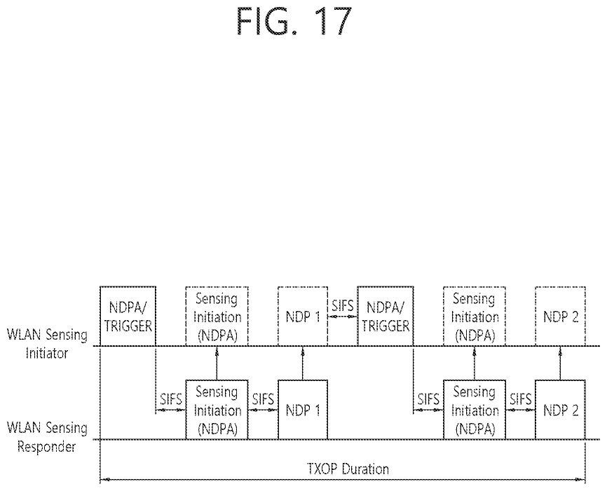

FIG. 17 is a diagram illustrating an embodiment of an implicit feedback operation method.

Referring to FIG. 17, whenever a responder transmits an NDP, an initiator may transmit a sensing initiation frame after a specific time. Before every NDP transmission, the responder may transmit a frame for sensing initiation.

For example, the initiator may transmit a sensing initiation frame (i.e., NDPA or Trigger frame). The responder may receive a sensing initiation frame from the initiator, and may transmit a sensing initiation frame (e.g., NDPA frame) notifying the initiator of initiating sensing before transmitting the sensing frame. Thereafter, the responder may transmit a sensing frame (i.e., NDP1) to the initiator. The initiator may receive the sensing frame and transmit a sensing initiation frame (i.e., NDPA or Trigger frame) to the responder again. Upon receiving the sensing initiation frame, the responder may transmit a sensing initiation frame (e.g., an NDPA frame) notifying the initiator of sensing initiation before transmitting the sensing frame. Thereafter, the responder may transmit a sensing frame (i.e., NDP2) to the initiator.

Here, the sensing initiation frame transmitted by the initiator and the sensing initiation frame transmitted by the responder may have different formats or include different information. Here, the sensing initiation frame transmitted by the initiator and the sensing initiation frame transmitted by the responder may have the same format or include the same information.

An existing NDPA frame or a trigger frame may be used as a sensing initiation frame, and an NDP frame may be used as a sensing frame. TXOP duration may include 2 or more sensing sessions. Here, the sensing session may include NDPA/TRIGGER transmission of the initiator, sensing initiation frame transmission of the responder, and NDP transmission.

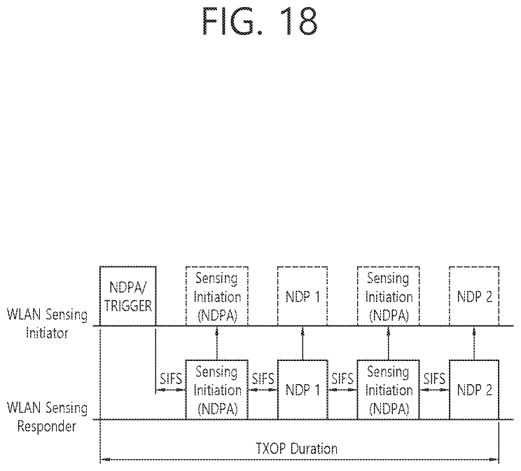

FIG. 18 is a diagram illustrating an embodiment of an implicit feedback operation method.

Referring to FIG. 18, the responder may transmit a frame for session initiation before every NDP transmission. A frame for sensing initiation may be a new frame or an existing frame.

For example, the initiator may transmit a sensing initiation frame (e.g., NDPA or Trigger frame). The responder may receive a sensing initiation frame from the initiator, and may transmit a sensing initiation frame (e.g., NDPA frame) notifying the initiator of initiating sensing before transmitting the sensing frame. Thereafter, the responder may transmit a sensing frame (i.e., NDP1) to the initiator. The initiator may receive a sensing frame. The responder may transmit a sensing initiation frame (e.g., NDPA frame) notifying the initiator of starting sensing. Thereafter, the responder may transmit a sensing frame (i.e., NDP2) to the initiator.

Here, the sensing initiation frame transmitted by the initiator and the sensing initiation frame transmitted by the responder may have different formats or include different information. Here, the sensing initiation frame transmitted by the initiator and the sensing initiation frame transmitted by the responder may have the same format or include the same information.

An existing NDPA frame or a trigger frame may be used as a sensing initiation frame, and an NDP frame may be used as a sensing frame. TXOP duration may include 2 or more sensing sessions. Here, the sensing session may include transmission of a responder's sensing initiation frame and NDP transmission.

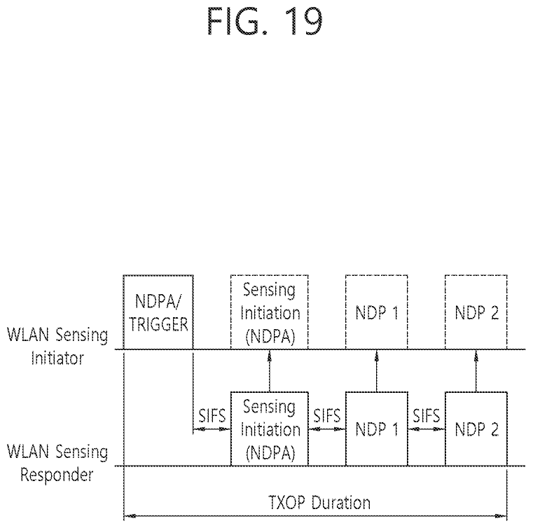

FIG. 19 is a diagram illustrating an embodiment of an implicit feedback operation method.

Referring to FIG. 19, a frame for session initiation may be transmitted before NDP transmission by a responder. A frame for sensing initiation may be a new frame or an existing frame.

For example, the initiator may transmit a sensing initiation frame (e.g., NDPA or Trigger frame). The responder may receive a sensing initiation frame from the initiator, and may transmit a sensing initiation frame (e.g., NDPA frame) notifying the initiator of initiating sensing before transmitting the sensing frame. Then, the responder may transmit a series of sensing frames (i.e., NDP1 and NDP2) to the initiator.

Here, the sensing initiation frame transmitted by the initiator and the sensing initiation frame transmitted by the responder may have different formats or include different information. Here, the sensing initiation frame transmitted by the initiator and the sensing initiation frame transmitted by the responder may have the same format or include the same information.

An existing NDPA frame or a trigger frame may be used as a sensing initiation frame, and an NDP frame may be used as a sensing frame. TXOP duration may include 2 or more sensing sessions. Here, the sensing session may include transmission of a responder's sensing initiation frame and a series of NDP transmissions.

Phase 2-3: Sensing Stage (Hybrid Feedback)

After transmission of the sensing initiation frame by the WLAN sensing initiator, a responder or initiator can transmit a signal usable for sensing by a predetermined time later.

The sensing frame may be defined as a new frame, or an existing frame may be used as the sensing frame. For example, an existing Null-Data Packet (NDP) frame may be used as a sensing frame.

For example, since Phase 2-3 is an embodiment related to the hybrid feedback method, the feedback method included in the sensing initiation frame may be “10”. That is, the sensing initiation frame may include information related to the hybrid feedback method.

Feedback may proceed according to the number of feedback frequencies included in the sensing initiation frame. For example, the feedback frequency information may include information related to whether feedback is performed for each sensing session or whether feedback is performed after the last sensing session. For example, the feedback frequency information may include a 2-bit indicator, and the 2-bit indicators may be set to one of “00” (feedback per session), “01” (feedback after last session), “10” (other), and “11” (reserved).

For example, when sensing feedback is set to be performed for each sensing session (e.g., “00”), the responder may transmit feedback after transmission of every sensing frame (e.g., NDP). Feedback may be requested by the initiator (e.g., feedback request signal transmission), or the responder may transmit feedback to the initiator after a specific time (e.g., Short Inter-Frame Space (SIFS)).

If sensing feedback is set to be performed after the last sensing session (e.g., “01”), in the case of the explicit feedback method, the responder sends feedback after all sensing frames (e.g., NDP) are transmitted. Feedback may be channel measurement information for every sensing frame (for example, NDP) or average channel measurement information for every sensing frame. That is, the sensing frame may include information related to measurement granularity. For example, the measurement granularity may include information related to a subcarrier unit in which channel estimation is performed. Feedback may be requested by the initiator (e.g., feedback request signal transmission), or the responder may transmit feedback to the initiator after a specific time (e.g., Short Inter-Frame Space (SIFS)). In the case of implicit feedback, the responder can continuously transmit NDP any number of times. All counts may be preset values in the sensing start frame or the like.

For example, when sensing feedback is set to be performed after transmission of a specific number of sensing frames (e.g., “10”), in the case of the explicit feedback method, after transmission of a specific number of sensing frames by the initiator, the responder feedback can be sent. Information on a specific number of times may be additionally included in the session initiation frame. Feedback may be channel measurement information for a specific number of NDPs or average channel measurement information for a specific number of NDP transmissions. For example, channel measurement can be performed according to the measurement granularity specified in the sensing initiation frame. Feedback may be requested by the initiator (e.g., feedback request signal transmission), and the responder may send feedback to the initiator after a specific time (e.g., SIFS (Short Inter-Frame Space), PIFS (PCF: Point Coordination Function IFS), DIFS (DCF: Distributed Coordination Function (IFS), EIFS (Extended IFS), or a newly defined time). In the case of implicit feedback, NDP transmission by the responder can proceed up to a specific number of times. For example, information related to the number of consecutively transmitted sensing frames may be based on information included in a sensing initiation frame. For example, the sensing initiation frame may include information related to the number of transmissions of the sensing frame. Information about a specific number of times may be included in a sensing initiation frame from an initiator, or may be included in a frame transmitted by a responder prior to transmission of a sensing signal. That is, the number of transmissions of sensing frames may be set by the responder. After a specific number of transmissions by the responder, sensing is initiated through a sensing initiation frame by the initiator, or the responder can restart/re-initiate after a specific time.

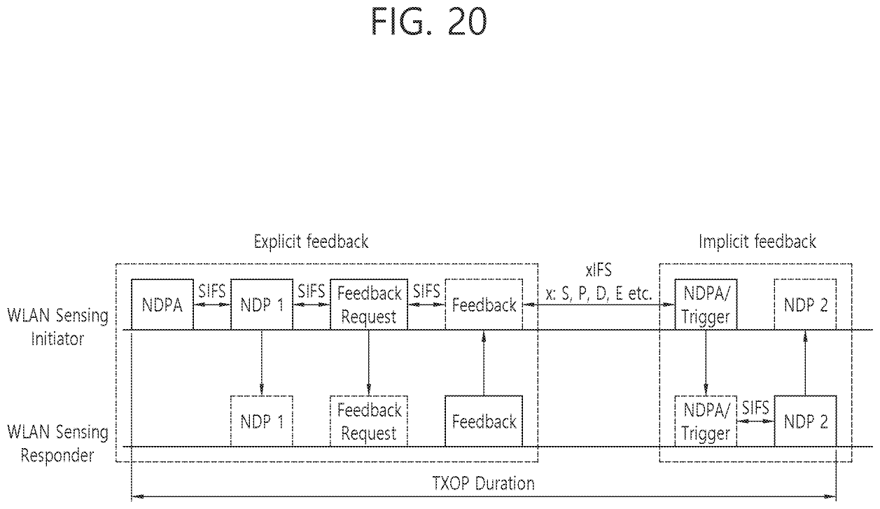

FIG. 20 is a diagram illustrating an embodiment of a hybrid feedback operation method.

Referring to FIG. 20, the first sensing session is based on explicit feedback in which the initiator requests feedback from the responder, and the second sensing session is based on implicit feedback in which the responder transmits sensing frames to the initiator. The time between the explicit feedback-based sensing session and the implicit feedback-based sensing session may be xIFS (e.g., SIFS, PIFS, DIFS, EIFS, or a newly defined time).

For example, the initiator may transmit a sensing initiation frame (i.e., NDPA) and may transmit a sensing frame (i.e., NDP1). The initiator may transmit a feedback request frame after transmitting the sensing frame. The responder may receive the feedback request frame and may transmit a feedback frame including channel state information based on the sensing frame.

For example, after xIFS, the initiator may transmit a sensing initiation frame (e.g., NDPA or Trigger frame). The responder may receive a sensing initiation frame and may transmit a sensing frame (i.e., NDP2).

An existing NDPA frame or a trigger frame may be used as a sensing initiation frame, and an NDP frame may be used as a sensing frame. TXOP duration may include 2 or more sensing sessions. The first sensing session is based on explicit feedback and may include NDPA transmission, NDP transmission, feedback request frame transmission, and feedback frame transmission. The second sensing session is based on implicit feedback and may include NDPA or trigger transmission and NDP transmission.

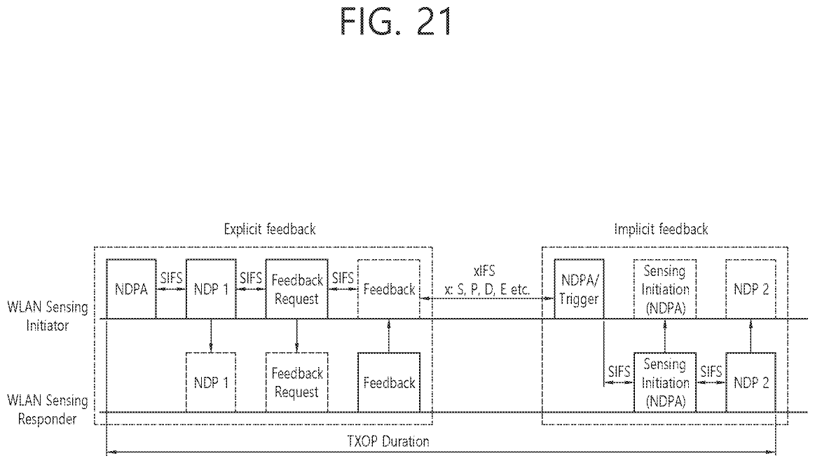

FIG. 21 is a diagram illustrating an embodiment of a hybrid feedback operation method.

Referring to FIG. 21, the first sensing session is based on explicit feedback in which the initiator requests feedback from the responder, and the second sensing session is based on implicit feedback in which the responder transmits a sensing frame to the initiator. The time between the explicit feedback-based sensing session and the implicit feedback-based sensing session may be xIFS (e.g., SIFS, PIFS, DIFS, EIFS, or a newly defined time). For example, in the case of the second implicit feedback, the responder may transmit a sensing initiation frame before transmitting the sensing frame.

For example, the initiator may transmit a sensing initiation frame (i.e., NDPA) and may transmit a sensing frame (i.e., NDP1). The initiator may transmit a feedback request frame after transmitting the sensing frame. The responder may receive the feedback request frame and may transmit a feedback frame including channel state information based on the sensing frame.

For example, after xIFS, the initiator may transmit a sensing initiation frame (e.g., NDPA or Trigger frame). The responder may receive the sensing initiation frame, and may transmit a sensing initiation frame (e.g., NDPA) indicating initiation of sensing prior to transmission of the sensing frame. Thereafter, the responder may transmit a sensing frame (i.e., NDP2).

Here, the sensing initiation frame transmitted by the initiator and the sensing initiation frame transmitted by the responder may have different formats or include different information. Here, the sensing initiation frame transmitted by the initiator and the sensing initiation frame transmitted by the responder may have the same format or include the same information.

An existing NDPA frame or a trigger frame may be used as a sensing initiation frame, and an NDP frame may be used as a sensing frame. TXOP duration may include 2 or more sensing sessions. The first sensing session is based on explicit feedback and may include NDPA transmission, NDP transmission, feedback request frame transmission, and feedback frame transmission. The second sensing session is based on implicit feedback and may include NDPA/Trigger transmission from the initiator and NDPA and NDP transmission from the responder.

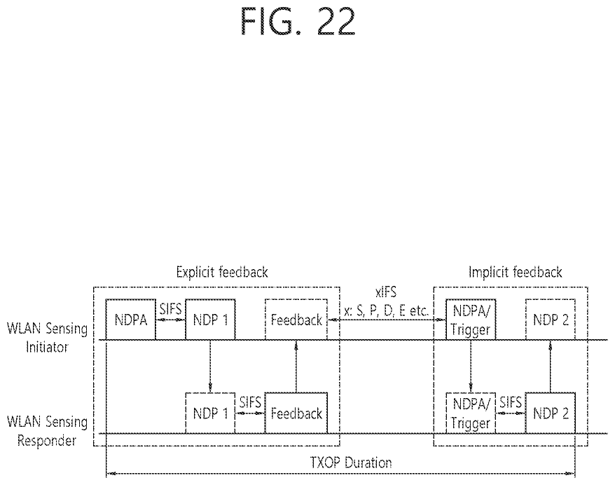

FIG. 22 is a diagram illustrating an embodiment of a hybrid feedback operation method.

Referring to FIG. 22, the first sensing session is based on explicit feedback in which the initiator requests feedback from the responder, and the second sensing session is based on implicit feedback in which the responder transmits a sensing frame to the initiator. The time between the explicit feedback-based sensing session and the implicit feedback-based sensing session may be xIFS (e.g., SIFS, PIFS, DIFS, EIFS, or a newly defined time). For example, in the case of the second implicit feedback, the responder may transmit a sensing initiation frame before transmitting the sensing frame.

For example, the initiator may transmit a sensing initiation frame (i.e., NDPA) and may transmit a sensing frame (i.e., NDP1). The responder may transmit a feedback frame including channel state information based on the sensing frame.

For example, after xIFS, the initiator may transmit a sensing initiation frame (e.g., NDPA or Trigger frame). The responder may receive a sensing initiation frame and may transmit a sensing frame (i.e., NDP2).

An existing NDPA frame or a trigger frame may be used as a sensing initiation frame, and an NDP frame may be used as a sensing frame. TXOP duration may include 2 or more sensing sessions. The first sensing session is based on explicit feedback and may include NDPA transmission, NDP transmission, and feedback frame transmission. The second sensing session is based on implicit feedback and may include NDPA/Trigger transmission from the initiator and NDP transmission from the responder.

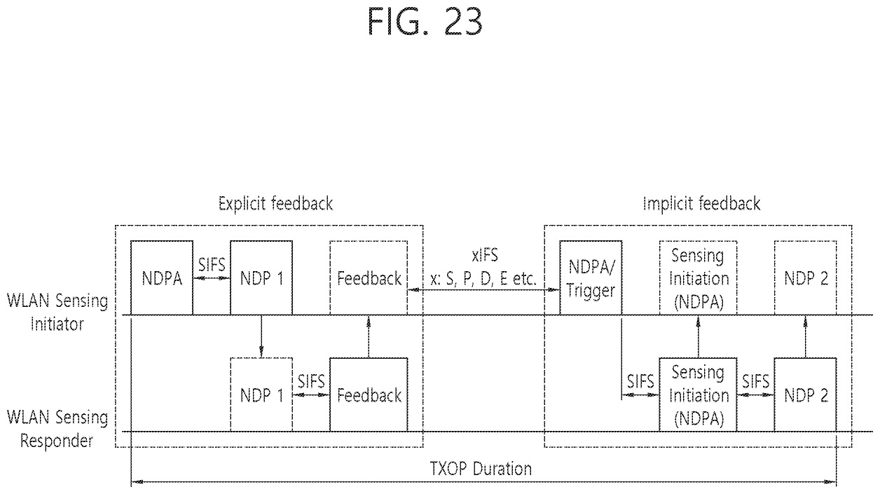

FIG. 23 is a diagram illustrating an embodiment of a hybrid feedback operation method.

Referring to FIG. 23, the first sensing session is based on explicit feedback in which the initiator requests feedback from the responder, and the second sensing session is based on implicit feedback in which the responder transmits a sensing frame to the initiator. The time between the explicit feedback-based sensing session and the implicit feedback-based sensing session may be xIFS (e.g., SIFS, PIFS, DIFS, EIFS, or a newly defined time). For example, in the case of the second implicit feedback, the responder may transmit a sensing initiation frame before transmitting the sensing frame.

For example, the initiator may transmit a sensing initiation frame (i.e., NDPA) and may transmit a sensing frame (i.e., NDP1). The responder may transmit a feedback frame including channel state information based on the sensing frame.

For example, after xIFS, the initiator may transmit a sensing initiation frame (e.g., NDPA or Trigger frame). The responder may receive the sensing initiation frame, and may transmit a sensing initiation frame (e.g., NDPA) indicating initiation of sensing prior to transmission of the sensing frame. Thereafter, the responder may transmit a sensing frame (i.e., NDP2).

Here, the sensing initiation frame transmitted by the initiator and the sensing initiation frame transmitted by the responder may have different formats or include different information. Here, the sensing initiation frame transmitted by the initiator and the sensing initiation frame transmitted by the responder may have the same format or include the same information.

An existing NDPA frame or a trigger frame may be used as a sensing initiation frame, and an NDP frame may be used as a sensing frame. TXOP duration may include 2 or more sensing sessions. The first sensing session is based on explicit feedback and may include NDPA transmission, NDP transmission, and feedback frame transmission. The second sensing session is based on implicit feedback and may include NDPA/Trigger transmission from the initiator and NDPA and NDP transmission from the responder.

The above Phases 2-1 to 2-3 may be performed independently of each other, may be performed in combination, or may be performed with some steps omitted in a combined form.

The WLAN sensing technique described above can be classified into an explicit feedback-based method and an implicit feedback-based method according to the feedback transmission method. Each feedback method has its strengths and weaknesses, and each method may be preferred depending on the use environment.

For example, if the initiator and responder have high-end capability in terms of WLAN sensing, the explicit feedback method may be preferred.

For example, if the initiator and the responder (or one of the two) are IoT devices with limited capabilities, feedback overhead reduction by the implicit feedback method may be important.

Depending on the situation, more accurate sensing performance can be realized by using both the explicit feedback method and the implicit feedback method (hybrid feedback method).

According to the embodiments of the present specification, both explicit or implicit feedback and explicit and implicit feedbacks (hybrid) methods can be supported, so that an optimal method according to the situation can be implemented.

The method proposed in present specification can be applied even when one or more sensing devices are formed as a group and operated. For example, an initiator and responders performing sensing may perform an operation of configuring a group to perform sensing, and a sensing operation may be performed based on the created group.

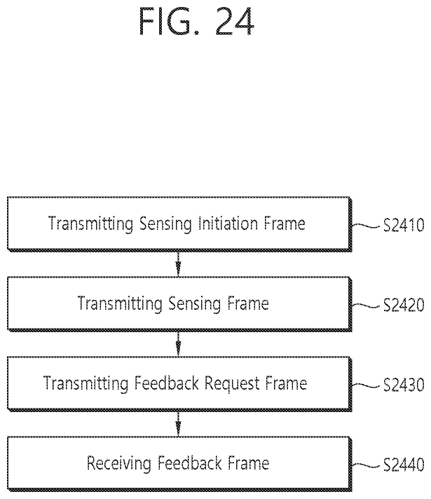

FIG. 24 is a diagram illustrating an embodiment of a method of operating a transmitting STA.

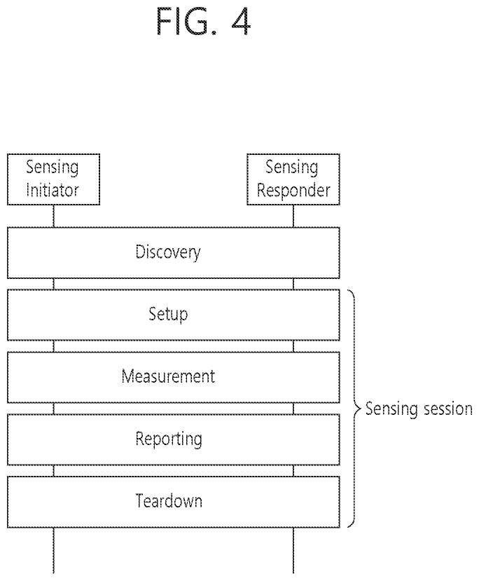

Referring to FIG. 24, a receiving STA operation may be based on technical features described in at least one of FIGS. 1 to 23.

The transmitting STA may transmit a sensing initiation frame (S2410). For example, the sensing initiation frame may include information related to a feedback method and a feedback frequency. For example, the feedback method may include information related to at least one of explicit feedback, implicit feedback, and hybrid feedback.

For example, the sensing initiation frame may further include information related to how many subcarriers the channel state information is measured in.

For example, the sensing initiation frame may further include information related to the number of transmissions of the sensing frame.

For example, the sensing initiation frame may include a null data packet announcement (NDPA) frame, and the sounding signal may include a null data packet (NDP) frame.

For example, the information related to the feedback frequency may include information related to how many sensing frames the receiving STA transmits after receiving a feedback frame.

For example, the explicit feedback is a method in which the transmitting STA that has transmitted the sensing initiation frame transmits the sensing frame, the implicit feedback is a method in which the receiving STA that has received the sensing initiation frame transmits the sensing frame, and the hybrid feedback is a method in which both the explicit feedback and the implicit feedback are used.

The WLAN Sensing initiator may transmit a sensing initiation frame for initiation of sensing. The sensing initiation frame may include information on a STA participating in sensing as a responder (e.g., AID, STA ID, etc.), sensing duration, number of times of sensing, feedback method, frequency of feedback, and information related to sensing information and feedback.

Sensing duration may be the TXOP duration obtained by the initiator. During the TXOP duration, the initiator and responder may perform one or more sensing sessions. Each sensing session can support explicit or implicit feedback. For example, the sensing session may include transmitting a sensing signal (e.g., an NDP frame) and transmitting feedback for the sensing signal. For example, the sensing duration may include at least one TXOP.

For example, the feedback method can be specified in explicit, implicit, or hybrid form by an indicator. For example, a signal for initiating sensing transmitted by an initiator (i.e., a sensing initiation frame) may include a 2-bit indicator, and a feedback method may be determined using the 2-bit indicator. For example, a 2-bit indicator may have values such as “00” (explicit feedback), “01” (implicit feedback), “10” (hybrid feedback), and “11” (reserved). That is, the sensing initiation frame may include information related to a feedback method, and the feedback method may be determined as at least one of explicit feedback, implicit feedback, and hybrid feedback.

The number of sensing may indicate the total number of sensing sessions to be performed during the TXOP Duration. For example, if the feedback method is designated as “00” (explicit feedback) and the number of sensing is designated as 5, this may mean that explicit feedback-based sensing is performed 5 times during TXOP (or sensing session).

For example, when the sensing feedback method is designated as hybrid (example “10” above), explicit and implicit feedback count information can be provided through additional information. For example, when the feedback method is a hybrid method, the sensing initiation frame may further include additional information necessary for performing the hybrid method.

The feedback frequency may include information on whether to transmit feedback for every session or after a specific session.

A sensing initiation frame that initiates a WLAN sensing session may use an existing frame (e.g., Null Data Packet Announcement (NDPA)) or a new frame. NDPA or new frame may include an indicator indicating that the purpose is WLAN Sensing.

The transmitting STA may transmit a sensing frame (S2420). For example, the transmitting STA may transmit a sensing frame to the receiving STA.

The transmitting STA may transmit a feedback request frame (S2430). For example, the transmitting STA may transmit a feedback request frame requesting the feedback frame to the receiving STA.

The transmitting STA may receive the feedback frame (S2440). For example, the transmitting STA may receive a feedback frame including channel state information obtained based on the sensing frame from the receiving STA.

Phase 1: Initiation Stage

The WLAN Sensing initiator may transmit a sensing initiation frame for initiation of sensing. The sensing initiation frame may include information on a STA participating in sensing as a responder (e.g., AID, STA ID, etc.), sensing duration, number of times of sensing, feedback method, frequency of feedback, and information related to sensing information and feedback.

Sensing duration may be a TXOP duration obtained by the initiator. During the TXOP duration, the initiator and responder may perform one or more sensing sessions. Each sensing session can support explicit or implicit feedback. For example, the sensing session may include transmitting a sensing signal (e.g., an NDP frame) and transmitting feedback for the sensing signal. For example, the sensing duration may include at least one TXOP.

For example, the feedback method can be specified inexplicit, implicit, or hybrid form by an indicator. For example, a signal for initiating sensing transmitted by an initiator (i.e., a sensing initiation frame) may include a 2-bit indicator, and a feedback method may be determined using the 2-bit indicator. For example, a 2-bit indicator may have values such as “00” (explicit feedback), “01” (implicit feedback), “10” (hybrid feedback), and “11” (reserved). That is, the sensing initiation frame may include information related to a feedback method, and the feedback method may be determined as at least one of explicit feedback, implicit feedback, and hybrid feedback.

The number of sensing may indicate the total number of sensing sessions to be performed during the TXOP Duration. For example, if the feedback method is designated as “00” (explicit feedback) and the number of sensing is designated as 5, this may mean that explicit feedback-based sensing is performed 5 times during TXOP (or sensing session).

For example, when the sensing feedback method is designated as hybrid (example “10” above), explicit and implicit feedback count information can be provided through additional information. For example, when the feedback method is a hybrid method, the sensing initiation frame may further include additional information necessary for performing the hybrid method.

The feedback frequency may include information on whether to transmit feedback for every session or after a specific session.

A sensing initiation frame that initiates a WLAN sensing session may use an existing frame (e.g., Null Data Packet Announcement (NDPA)) or a new frame. NDPA or new frame may include an indicator indicating that the purpose is WLAN Sensing.

Phase 2-1: Sensing Stage (Explicit Feedback)

The WLAN sensing initiator may transmit a sensing frame used for sensing to a responder at a predetermined time after transmission of the sensing initiation frame.

The sensing frame may be defined as a new frame, or an existing frame may be used as the sensing frame. For example, an existing Null-Data Packet (NDP) frame may be used as a sensing frame.

For example, since Phase 2-1 is an embodiment related to the explicit feedback method, the feedback method included in the sensing initiation frame may be “00”. That is, the sensing initiation frame may include information related to an explicit feedback method.

Feedback may proceed according to the number of feedback frequencies included in the sensing initiation frame. For example, the feedback frequency information may include information related to whether feedback is performed for each sensing session or whether feedback is performed after the last sensing session. For example, the feedback frequency information may include a 2-bit indicator, and the 2-bit indicators may be set to one of “00” (feedback per session), “01” (feedback after last session), “10” (other), and “11” (reserved).

For example, when sensing feedback is set to be performed for each sensing session (e.g., “00”), the responder may transmit feedback after transmission of every sensing frame (e.g., NDP). Feedback may be requested by the initiator (e.g., feedback request signal transmission), or the responder may transmit feedback to the initiator after a specific time (e.g., Short Inter-Frame Space (SIFS)).

If sensing feedback is set to be performed after the last sensing session (e.g., “01”), the responder may transmit feedback after all sensing frames (e.g., NDP) are transmitted. Feedback may be channel measurement information for each sensing frame (e.g., NDP) or average channel measurement information for all sensing frames. Channel measurement can be performed according to the measurement granularity specified in the sensing start frame. That is, the sensing frame may include information related to measurement granularity. For example, measurement granularity may include information related to a subcarrier unit in which channel estimation is performed. Feedback may be requested by the initiator (e.g., feedback request signal transmission), or the responder may transmit feedback to the initiator after a specific time (e.g., Short Inter-Frame Space (SIFS)).

For example, if sensing feedback is set to be performed after transmission of a specific number of sensing frames (e.g., “10”), the responder may transmit feedback after transmission of a specific number of sensing frames by an initiator. Information on a specific number of times may be additionally included in the session initiation frame. Feedback may be channel measurement information for a specific number of NDPs or average channel measurement information for a specific number of NDP transmissions. For example, channel measurement can be performed according to the measurement granularity specified in the sensing initiation frame. Feedback may be requested by the initiator (e.g., feedback request signal transmission), or the responder may transmit feedback to the initiator after a specific time (e.g., Short Inter-Frame Space (SIFS)).

Phase 2-2: Sensing Stage (Implicit Feedback)

The WLAN sensing responder may transmit a sensing frame used for sensing to the initiator at a predetermined time after receiving the sensing initiation frame.

The sensing frame may be defined as a new frame, or an existing frame may be used as the sensing frame. For example, an existing Null-Data Packet (NDP) frame may be used as a sensing frame.

Prior to transmission of the sensing frame, transmission of a frame (e.g., sensing initiation frame) including information related to transmission of the sensing frame may be performed first.

For example, since Phase 2-2 is an embodiment related to the implicit feedback method, the feedback method included in the sensing initiation frame may be “Ol”. That is, the sensing initiation frame may include information related to the implicit feedback method.

Feedback may proceed according to the number of feedback frequencies included in the sensing initiation frame. For example, the feedback frequency information may include information related to whether feedback is performed for each sensing session or whether feedback is performed after the last sensing session. For example, the feedback frequency information may include a 2-bit indicator, and the 2-bit indicators may be set to one of “00” (feedback per session), “01” (feedback after last session), “10” (other), and “11” (reserved).

However, in the implicit feedback method, the responder only transmits the sensing frame (i.e., the NDP frame) to the initiator, and the feedback frame is not separately transmitted. Therefore, the number of feedback frequencies may have a different meaning from the above explicit feedback.

For example, when sensing feedback frequency information is set to “00”, after each NDP transmission by a responder, an initiator may transmit a sensing initiation frame after a specific time (e.g., SIFS).

For example, if sensing feedback frequency information is set to “01”, the responder can transmit NDP all times. All counts may be preset values in the sensing initiation frame or the like.

For example, if information on the number of feedback frequencies of sensing is set to “10”, the responder can continuously transmit sensing frames a specific number of times after receiving a sensing initiation frame. For example, information related to the number of consecutively transmitted sensing frames may be based on information included in a sensing initiation frame. For example, the sensing initiation frame may include information related to the number of transmissions of the sensing frame. Information about a specific number of times may be included in a sensing initiation frame from an initiator, or may be included in a frame transmitted by a responder prior to transmission of a sensing signal. That is, the number of transmissions of sensing frames may be set by the responder. After a specific number of transmissions by the responder, sensing is initiated through a sensing initiation frame by the initiator, or the responder can restart/re-initiate after a specific time.

Phase 2-3: Sensing Stage (Hybrid Feedback)

After transmission of the sensing initiation frame by the WLAN sensing initiator, a responder or initiator can transmit a signal usable for sensing by a predetermined time later.

The sensing frame may be defined as a new frame, or an existing frame may be used as the sensing frame. For example, an existing Null-Data Packet (NDP) frame may be used as a sensing frame.

For example, since Phase 2-3 is an embodiment related to the hybrid feedback method, the feedback method included in the sensing initiation frame may be “10”. That is, the sensing initiation frame may include information related to the hybrid feedback method.

Feedback may proceed according to the number of feedback frequencies included in the sensing initiation frame. For example, the feedback frequency information may include information related to whether feedback is performed for each sensing session or whether feedback is performed after the last sensing session. For example, the feedback frequency information may include a 2-bit indicator, and the 2-bit indicators may be set to one of “00” (feedback per session), “01” (feedback after last session), “10” (other), and “11” (reserved).

For example, when sensing feedback is set to be performed for each sensing session (e.g., “00”), the responder may transmit feedback after transmission of every sensing frame (e.g., NDP). Feedback may be requested by the initiator (e.g., feedback request signal transmission), or the responder may transmit feedback to the initiator after a specific time (e.g., Short Inter-Frame Space (SIFS)).

If sensing feedback is set to be performed after the last sensing session (e.g., “01”), in the case of the explicit feedback method, the responder sends feedback after all sensing frames (e.g., NDP) are transmitted. Feedback may be channel measurement information for every sensing frame (for example, NDP) or average channel measurement information for every sensing frame. That is, the sensing frame may include information related to measurement granularity. For example, the measurement granularity may include information related to a subcarrier unit in which channel estimation is performed. Feedback may be requested by the initiator (e.g., feedback request signal transmission), or the responder may transmit feedback to the initiator after a specific time (e.g., Short Inter-Frame Space (SIFS)). In the case of implicit feedback, the responder can continuously transmit NDP any number of times. All counts may be preset values in the sensing start frame or the like.

For example, when sensing feedback is set to be performed after transmission of a specific number of sensing frames (e.g., “10”), in the case of the explicit feedback method, after transmission of a specific number of sensing frames by the initiator, the responder feedback can be sent. Information on a specific number of times may be additionally included in the session initiation frame. Feedback may be channel measurement information for a specific number of NDPs or average channel measurement information for a specific number of NDP transmissions. For example, channel measurement can be performed according to the measurement granularity specified in the sensing initiation frame. Feedback may be requested by the initiator (e.g., feedback request signal transmission), and the responder may send feedback to the initiator after a specific time (e.g., SIFS (Short Inter-Frame Space), PIFS (PCF: Point Coordination Function IFS), DIFS (DCF: Distributed Coordination Function (IFS), EIFS (Extended IFS), or a newly defined time). In the case of implicit feedback, NDP transmission by the responder can proceed up to a specific number of times. For example, information related to the number of consecutively transmitted sensing frames may be based on information included in a sensing initiation frame. For example, the sensing initiation frame may include information related to the number of transmissions of the sensing frame. Information about a specific number of times may be included in a sensing initiation frame from an initiator, or may be included in a frame transmitted by a responder prior to transmission of a sensing signal. That is, the number of transmissions of sensing frames may be set by the responder. After a specific number of transmissions by the responder, sensing is initiated through a sensing initiation frame by the initiator, or the responder can restart/re-initiate after a specific time.

The above Phases 2-1 to 2-3 may be performed independently of each other, may be performed in combination, or may be performed with some steps omitted in a combined form.

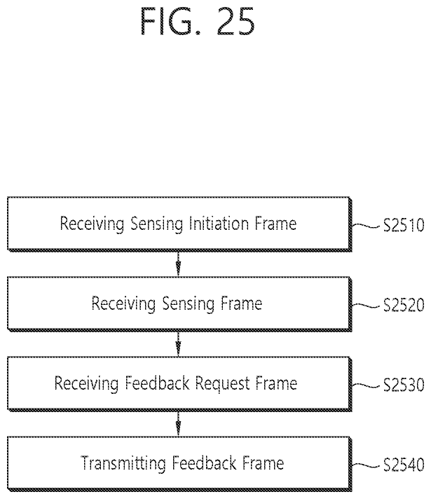

FIG. 25 is a diagram illustrating an embodiment of a method of operating a receiving STA.

Referring to FIG. 25, a receiving STA operation may be based on technical features described in at least one of FIGS. 1 to 23.

The receiving STA may receive a sensing initiation frame (S2510). For example, the sensing initiation frame may include information related to a feedback method and a feedback frequency. For example, the feedback method may include information related to at least one of explicit feedback, implicit feedback, and hybrid feedback.

For example, the sensing initiation frame may further include information related to how many subcarriers the channel state information is measured in.

For example, the sensing initiation frame may further include information related to the number of transmissions of the sensing frame.

For example, the sensing initiation frame may include a null data packet announcement (NDPA) frame, and the sounding signal may include a null data packet (NDP) frame.

For example, the information related to the feedback frequency may include information related to how many sensing frames the receiving STA transmits after receiving a feedback frame.

For example, the explicit feedback is a method in which the transmitting STA that has transmitted the sensing initiation frame transmits the sensing frame, the implicit feedback is a method in which the receiving STA that has received the sensing initiation frame transmits the sensing frame, and the hybrid feedback is a method in which both the explicit feedback and the implicit feedback are used.

The WLAN Sensing initiator may transmit a sensing initiation frame for initiation of sensing. The sensing initiation frame may include information on a STA participating in sensing as a responder (e.g., AID, STA ID, etc.), sensing duration, number of times of sensing, feedback method, frequency of feedback, and information related to sensing information and feedback.

Sensing duration may be the TXOP duration obtained by the initiator. During the TXOP duration, the initiator and responder may conduct one or more sensing sessions. Each sensing session can support explicit or implicit feedback. For example, the sensing session may include transmitting a sensing signal (e.g., an NDP frame) and transmitting feedback for the sensing signal. For example, the sensing duration may include at least one TXOP.

For example, the feedback method can be specified inexplicit, implicit, or hybrid form by an indicator. For example, a signal for initiating sensing transmitted by an initiator (i.e., a sensing initiation frame) may include a 2-bit indicator, and a feedback method may be determined using the 2-bit indicator. For example, a 2-bit indicator may have values such as “00” (explicit feedback), “01” (implicit feedback), “10” (hybrid feedback), and “11” (reserved). That is, the sensing initiation frame may include information related to a feedback method, and the feedback method may be determined as at least one of explicit feedback, implicit feedback, and hybrid feedback.

The number of sensing may indicate the total number of sensing sessions to be performed during the TXOP Duration. For example, if the feedback method is designated as “00” (explicit feedback) and the number of sensing is designated as 5, this may mean that explicit feedback-based sensing is performed 5 times during TXOP (or sensing session).

For example, when the sensing feedback method is designated as hybrid (example “10” above), explicit and implicit feedback count information can be provided through additional information. For example, when the feedback method is a hybrid method, the sensing initiation frame may further include additional information necessary for performing the hybrid method.

The feedback frequency may include information on whether to transmit feedback for every session or after a specific session.

A sensing initiation frame that initiates a WLAN sensing session may use an existing frame (e.g., Null Data Packet Announcement (NDPA)) or a new frame. NDPA or new frame may include an indicator indicating that the purpose is WLAN Sensing.

The receiving STA may receive the sensing frame (S2520). For example, the receiving STA may receive a sensing frame from the transmitting STA.

The receiving STA may receive a feedback request frame (S2530). For example, the receiving STA may transmit a feedback request frame requesting the feedback frame from the transmitting STA.

The receiving STA may transmit a feedback frame (S2440). For example, the receiving STA may transmit a feedback frame including channel state information obtained based on the sensing frame to the transmitting STA.

Some of the detailed steps shown in the examples of FIGS. 24 and 25 may not be essential steps and may be omitted. In addition to the steps shown in FIGS. 24 and 25, other steps may be added, and the order of the steps may be changed. Some of the above steps may have their own independent technical meaning.

The technical features of the present specification described above may be applied to various devices and methods. For example, the technical features of the present specification described above may be performed/supported through the device of FIGS. 1 and/or 9. For example, the technical features of the present specification described above may be applied only to a part of FIGS. 1 and/or 9. For example, the technical features of the present specification described above are implemented based on the processing chips 114 and 124 of FIG. 1, implemented based on the processors 111 and 121 and the memories 112 and 122 of FIG. 1, or may be implemented based on the processor 910 and the memory 920 of FIG. 9. For example, in the device of the present specification, the device includes a memory; and a processor operatively coupled to the memory, wherein the processor is adapted to: transmit a sensing initiation frame, wherein the sensing initiation frame includes information related to a feedback method and a feedback frequency, wherein the feedback method includes information related to at least one of explicit feedback, implicit feedback, and hybrid feedback; transmit a sensing frame to a receiving station (STA); and receive a feedback frame including channel state information obtained based on the sensing frame from the receiving STA.

Technical features of the present specification may be implemented based on a computer readable medium (CRM). For example, the CRM proposed by the present specification stores instructions that, based on being executed by at least one processor of a transmitting station (STA) in a wireless local area network (WLAN), perform operations comprising: transmitting a sensing initiation frame, wherein the sensing initiation frame includes information related to a feedback method and a feedback frequency, wherein the feedback method includes information related to at least one of explicit feedback, implicit feedback, and hybrid feedback; transmitting a sensing frame to a receiving STA; and receiving a feedback frame including channel state information obtained based on the sensing frame from the receiving STA.

Instructions stored in the CRM of the present specification may be executed by at least one processor. At least one processor related to the CRM of the present specification may be the processors 111 and 121 or the processing chips 114 and 124 of FIG. 1 or the processor 910 of FIG. 9. Meanwhile, the CRM of present specification may be the memories 112 and 122 of FIG. 1, the memory 920 of FIG. 9, or a separate external memory/storage medium/disk.

The foregoing technical features of the present specification are applicable to various applications or business models. For example, the foregoing technical features may be applied for wireless communication of a device supporting artificial intelligence (AI).

Artificial intelligence refers to a field of study on artificial intelligence or methodologies for creating artificial intelligence, and machine learning refers to a field of study on methodologies for defining and solving various issues in the area of artificial intelligence. Machine learning is also defined as an algorithm for improving the performance of an operation through steady experiences of the operation.

An artificial neural network (ANN) is a model used in machine learning and may refer to an overall problem-solving model that includes artificial neurons (nodes) forming a network by combining synapses. The artificial neural network may be defined by a pattern of connection between neurons of different layers, a learning process of updating a model parameter, and an activation function generating an output value.

The artificial neural network may include an input layer, an output layer, and optionally one or more hidden layers. Each layer includes one or more neurons, and the artificial neural network may include synapses that connect neurons. In the artificial neural network, each neuron may output a function value of an activation function of input signals input through a synapse, weights, and deviations.

A model parameter refers to a parameter determined through learning and includes a weight of synapse connection and a deviation of a neuron. A hyper-parameter refers to a parameter to be set before learning in a machine learning algorithm and includes a learning rate, the number of iterations, a mini-batch size, and an initialization function.

Learning an artificial neural network may be intended to determine a model parameter for minimizing a loss function. The loss function may be used as an index for determining an optimal model parameter in a process of learning the artificial neural network.

Machine learning may be classified into supervised learning, unsupervised learning, and reinforcement learning.

Supervised learning refers to a method of training an artificial neural network with a label given for training data, wherein the label may indicate a correct answer (or result value) that the artificial neural network needs to infer when the training data is input to the artificial neural network. Unsupervised learning may refer to a method of training an artificial neural network without a label given for training data Reinforcement learning may refer to a training method for training an agent defined in an environment to choose an action or a sequence of actions to maximize a cumulative reward in each state.

Machine learning implemented with a deep neural network (DNN) including a plurality of hidden layers among artificial neural networks is referred to as deep learning, and deep learning is part of machine learning. Hereinafter, machine learning is construed as including deep learning.

The foregoing technical features may be applied to wireless communication of a robot.

Robots may refer to machinery that automatically process or operate a given task with own ability thereof. In particular, a robot having a function of recognizing an environment and autonomously making a judgment to perform an operation may be referred to as an intelligent robot.

Robots may be classified into industrial, medical, household, military robots and the like according uses or fields. A robot may include an actuator or a driver including a motor to perform various physical operations, such as moving a robot joint. In addition, a movable robot may include a wheel, a brake, a propeller, and the like in a driver to run on the ground or fly in the air through the driver.

The foregoing technical features may be applied to a device supporting extended reality.

Extended reality collectively refers to virtual reality (VR), augmented reality (AR), and mixed reality (MR). VR technology is a computer graphic technology of providing a real-world object and background only in a CG image, AR technology is a computer graphic technology of providing a virtual CG image on a real object image, and MR technology is a computer graphic technology of providing virtual objects mixed and combined with the real world.

MR technology is similar to AR technology in that a real object and a virtual object are displayed together. However, a virtual object is used as a supplement to a real object in AR technology, whereas a virtual object and a real object are used as equal statuses in MR technology.

XR technology may be applied to ahead-mount display (HMD), ahead-up display (HUD), a mobile phone, a tablet PC, a laptop computer, a desktop computer, a TV, digital signage, and the like. A device to which XR technology is applied may be referred to as an XR device.

The claims recited in the present specification may be combined in a variety of ways. For example, the technical features of the method claims of the present specification may be combined to be implemented as a device, and the technical features of the device claims of the present specification may be combined to be implemented by a method. In addition, the technical characteristics of the method claim of the present specification and the technical characteristics of the device claim may be combined to be implemented as a device, and the technical characteristics of the method claim of the present specification and the technical characteristics of the device claim may be combined to be implemented by a method.

1. A method performed in a transmitting station (STA) of a wireless local area network (WLAN) system, the method comprising:
transmitting a sensing initiation frame, wherein the sensing initiation frame includes information related to a feedback method and a feedback frequency,
wherein the feedback method includes information related to at least one of explicit feedback, implicit feedback, and hybrid feedback;
transmitting a sensing frame to a receiving STA; and
receiving a feedback frame including channel state information obtained based on the sensing frame from the receiving STA.

2. The method of claim 1, wherein the sensing initiation frame further includes information related to how many subcarriers the channel state information is measured in.

3. The method of claim 1, wherein the sensing initiation frame further includes information related to a number of transmissions of the sensing frame.

4. The method of claim 1, wherein the sensing initiation frame includes a null data packet announcement (NDPA) frame, and the sounding signal includes a null data packet (NDP) frame.

5. The method of claim 1, wherein the information related to the feedback frequency includes information related to how many sensing frames the receiving STA transmits after receiving the feedback frame.

6. The method of claim 1, wherein the explicit feedback is a method in which the transmitting STA that has transmitted the sensing initiation frame transmits the sensing frame,
wherein the implicit feedback is a method in which the receiving STA that has received the sensing initiation frame transmits the sensing frame, and
wherein the hybrid feedback is a method in which both the explicit feedback and the implicit feedback are used.

7. The method of claim 1, wherein the transmitting STA transmits a feedback request frame requesting the feedback frame to the receiving STA.

8. A transmitting station (STA) of a wireless local area network (WLAN) system, the transmitting STA comprising:
a transceiver transmitting and/or receiving a wireless signal; and
a processor coupled to the transceiver,
wherein the processor is adapted to:
transmit a sensing initiation frame, wherein the sensing initiation frame includes information related to a feedback method and a feedback frequency,
wherein the feedback method includes information related to at least one of explicit feedback, implicit feedback, and hybrid feedback;
transmit a sensing frame to a receiving STA; and
receive a feedback frame including channel state information obtained based on the sensing frame from the receiving STA.

9. The transmitting STA of claim 8, wherein the sensing initiation frame further includes information related to how many subcarriers the channel state information is measured in.

10. The transmitting STA of claim 8, wherein the sensing initiation frame further includes information related to a number of transmissions of the sensing frame.

11. The transmitting STA of claim 8, wherein the sensing initiation frame includes a null data packet announcement (NDPA) frame, and the sounding signal includes a null data packet (NDP) frame.

12. The transmitting STA of claim 8, wherein the information related to the feedback frequency includes information related to how many sensing frames the receiving STA transmits after receiving the feedback frame.

13. The transmitting STA of claim 8, wherein the explicit feedback is a method in which the transmitting STA that has transmitted the sensing initiation frame transmits the sensing frame,
wherein the implicit feedback is a method in which the receiving STA that has received the sensing initiation frame transmits the sensing frame, and
wherein the hybrid feedback is a method in which both the explicit feedback and the implicit feedback are used.

14. The transmitting STA of claim 8, wherein the processor is further adapted to transmit a feedback request frame requesting the feedback frame to the receiving STA.

15. (canceled)

16. A receiving station (STA) of a wireless local area network (WLAN) system, the receiving STA comprising:
a transceiver transmitting and/or receiving a wireless signal; and
a processor coupled to the transceiver,
wherein the processor is adapted to:
receive a sensing initiation frame from a transmitting STA, wherein the sensing initiation frame includes information related to a feedback method and a feedback frequency,
wherein the feedback method includes information related to at least one of explicit feedback, implicit feedback, and hybrid feedback;
receive a sensing frame from the transmitting STA; and
transmit a feedback frame including channel state information obtained based on the sensing frame to the transmitting STA.

17-18. (canceled)
